(19) United States
(12) Patent Application Publication
(10) Pub. No.: US 2026/0336459 A1
(43) Pub. Date: Oct. 29, 2026

(54) SYSTEMS AND METHODS FOR REDUCING NON-RENEWABLE POWER GENERATION FOR CHARGING ELECTRIC ASSETS

(71) Applicant: BluWave Inc., Ottawa (CA)

(72) Inventors: Devashish PAUL, Ottawa (CA); Thomas TRIPLET, Ottawa (CA); Babak ASGHARI, Vancouver (CA); Keegan Michael John GREEN, Ottawa (CA)

(21) Appl. No.: 19/189,942

(22) Filed: Apr. 25, 2025

(51) Int. Cl. B60L 53/66; B60L 53/50; B60L 53/62

(52) U.S. Cl. CPC B60L 53/665; B60L 53/50; B60L 53/62

(57) ABSTRACT

Systems and methods for providing control in relation to charging of electric vehicles (EVs) are provided. The charging is performed using power received at least in part from a non-renewable power generation system that is separate from a power grid or other conventional source of power. The charging may be performed at a site having limited or no access to power from a grid. A system generates charging control information for the EVs, and generates non-renewable power generation control information with a power generation setpoint for the non-renewable power generation system. The non-renewable power generation control information may be at least partly based on the charging control information. The generated charging and power generation control information seeks to minimize fuel consumption by the non-renewable power generation system.

### REFERENCE TO RELATED APPLICATIONS

(none)

### FIELD

The present disclosure relates generally to systems, apparatuses, and methods for providing control in relation to non-renewable power generation and charging of electric vehicles (EVs) or other assets.

### BACKGROUND

In various applications, there is often little to no consideration of whether energy used by vehicles and other equipment and assets consume fossil fuels or emit greenhouse gases (GHGs). In some applications, the availability of power from an electrical grid may be limited or absent. Accordingly, some power may be generated locally on-site, for example using fossil fuel electric generators, to provide power to the site. However, the amount of power generated is often not sufficient to also permit the charging of numerous EVs or other electric equipment. Thus, the ease of transitioning some of the vehicles or other equipment from fossil fuels to electric power may be challenging at least due to limited or absent availability of electrical power from a power grid. Improvements are desired.

The above information is presented as background information only to assist with an understanding of the present disclosure. No assertion or admission is made as to whether any of the above, or anything else in the present disclosure, unless explicitly stated, might be applicable as prior art with regard to the present disclosure.

### BRIEF DESCRIPTION OF DRAWINGS

Example embodiments of the present disclosure will now be described with reference to the attached Figures.

FIG. 1 consists of graphs showing examples of the minimum power that must be supplied by diesel generation over time, which may be the power consumed by mining assets for charging minus some lesser amount of on-site renewable generation, if present. The actual amount of power supplied by diesel generation may have to be a greater, constant value, resulting in wasted energy.

FIG. 2 consists of graphs showing an example of augmenting a constant supply of power from diesel with the charging and discharging of an energy storage system (ESS) to get the precise amount of power needed over time, for example for charging EVs.

FIG. 3 consists of graphs showing an example of charging and discharging an ESS to make up for differences between on-site renewable power generation and power consumption by mining EVs.

FIG. 4 is a block diagram of an example system comprising a power control system, a plurality of EVs, and a non-renewable power generation system.

FIG. 5 is a block diagram of an example configuration and process showing some example types of inputs and actions or other operations in relation to a power control system.

FIG. 6 is a diagram illustrating an example of a receding-horizon optimization scheme.

FIG. 7 is a block diagram showing a representation of an example system with example optimization objectives, and inputs and outputs of a controller/optimizer of a power control system.

FIG. 8 is an example of peak shaving showing non-optimized versus optimized charging power simulated for two days for a fleet of mining EVs.

FIG. 9 is an example timing diagram showing an example of a non-optimized case with charging sessions for five mining EVs.

FIG. 10 is an example timing diagram of a similar scenario as in FIG. 9 except where an optimizer performs peak shaving.

FIG. 11 is an example timing diagram of a similar scenario as in FIG. 9 and FIG. 10 except where an optimizer may do peak shaving for an amount of power that must be supplied by diesel generation and where there is ample on-site renewable generation.

FIG. 12 shows an example of when an optimizer is aware of currently plugged-in EVs but has limited or no information about any EVs that may plug-in during an optimization horizon.

FIG. 13 shows an example of when an optimizer is aware of currently plugged-in EVs and also has some information about E Vs that may be expected or predicted to plug-in during an optimization horizon.

FIG. 14 is similar to FIG. 8 except where the optimization is electricity cost minimization rather than peak shaving.

FIG. 15 is a process flow diagram of an example method.

FIG. 16 is a block diagram of an example computerized device or system that may be used in implementing one or more aspects or components of one or more embodiments according to the present disclosure.

The relative sizes and relative positions of elements in the drawings are not necessarily drawn to scale. For example, the shapes of various elements and angles are not necessarily drawn to scale, and some of these elements may be arbitrarily enlarged and/or positioned to improve the readability of the drawings. Further, the particular shapes of the elements as drawn are not necessarily intended to convey any information regarding the actual shape of the particular elements, and have been solely selected for ease of recognition in the drawings.

### DETAILED DESCRIPTION

This disclosure generally relates to improvements in EV control technologies, including systems, apparatuses, and methods for providing control in relation to EVs and fleets of EVs, vehicles, equipment, and other assets. In addition, this disclosure generally relates to improvements in power generation control technologies, for example non-renewable power generation, which may be used, for example, to charge EVs or other equipment. Furthermore, in at least some embodiments, systems and methods minimize or reduce how much a non-renewable power generation system is used to provide power to charge EVs, and thus how much fuel is used.

As EVs become more popular, vehicle fleets are increasingly becoming electrified. EVs have the potential to be supplied with clean or cleaner energy. The electrification of EVs may apply to vehicles and equipment in various industries and applications, including mining vehicles and equipment. Mining vehicles are typically much larger than many commercial and consumer vehicles, often have greater energy requirements, and are usually very expensive to acquire and operate. To maximize return on investment, mining vehicles are often used almost continuously with exceptions for being taken out of operation to refuel or for maintenance. Being able to operate hybrid or fully electric mining vehicles in a similar fashion, with efficient or optimized charging instead of refueling may be important to making the electrification of mining vehicle fleets an attractive option for mining companies to reduce their carbon footprint. However, mining vehicles typically operate in remote areas where the availability of power from an electrical grid may be limited or absent.

Mines are seldom connected to an electrical grid. Thus, they often operate like decentralized “microgrids” and may be powered by one or more non-renewable power generators rather than by other power sources. A non-renewable power generator generally refers to a generator that is powered by a non-renewable energy source, for example by a fossil fuel such as diesel. This may pose challenges when attempting to electrify their fleets of mining vehicles because more generators, or larger ones, would typically need to be installed and maintained. This may present challenges to mine operators, such as the increased complexities and costs of having more and/or larger generators. This imposes a greater barrier to fleet electrification and thus to GHG reduction because some amount of diesel would have to be burned in any case, albeit in a generator rather than directly in the vehicles. One of the most important differences between the way traditional mining assets are powered by diesel and the way electrified mining assets are recharged by diesel generators is the fact that diesel generators must often continuously generate and expend power, which is wasted if not used to charge assets or for some other purpose. Thus, power produced by diesel generators that is wasted represents wasted costs to a mine operator. Furthermore, such wasted power also produces unnecessary GHG emissions.

Generators may be powered by diesel, gasoline, propane, natural gas, biodiesel, dual fuels, hydrogen, or any other fuel, although for ease of explanation and without any limitation, generators and generation are often referred to herein as diesel or non-renewable generators/generation. However, such references to diesel or non-renewable generators/generation apply to generators and generation from other fuel sources.

In addition, any on-site renewable generation, such as wind, solar or any other renewable source, if present, may alone be insufficient to reduce the overall GHG emissions, or to reduce the amount of diesel generation needed, if diesel must be burned during times of low renewable energy and potentially wasted during times of high renewable energy. These challenges inevitably present barriers to being able to use renewable energy at mines. Furthermore, while large ESSs may be used to store renewable energy and reduce diesel usage, they can present yet another high up-front and maintenance cost to a mine operator.

In addition, presently, for electric mining equipment and vehicles that exist, there is not necessarily any optimization of when during operations they are charged, at what power level, and how many vehicles are charged at the same or overlapping times. The adoption of electric mining vehicles may be avoided if a connection to an electrical grid is not available or the amount of power from a grid is insufficient to satisfy the charging requirements for vehicles. Alternatively, diesel generators may be used to produce electricity. There are often no on-site renewables or energy storage systems (ESSs) and, if there are, they are not fully or optimally taken advantage of to generate and store energy which can include clean energy.

A power generator, such as one powered by diesel, gasoline, or any other fuel, may not be able to be set to an arbitrary power generation level or output, but instead may only be set at one or more discrete power generation level setpoints. This means that when a generator is used, its power generation may be held constant for a period of time. The term “power generation level setpoint” is sometimes referred to herein as a “power generation level”, “setpoint”, or similar, for simplicity. From one of these power generation time periods to the next, the required amount of diesel generation may change and thus the setpoint may be reevaluated and adjusted. However, the power that must be supplied at a mine with electrified mining assets likely varies with time at a faster pace. This is especially the case when the power that must be supplied is equal to the power consumption of the mine minus some power generated from on-site renewable sources, which are often intermittent. Thus, one or more generators must be kept running for a period of time at a certain power generation setpoint to be able to meet the highest demand for power expected over that power generation time period. This often means that the difference between (a) the approximately-constant power generation, and (b) the varying power consumption, is wasted until a new setpoint can be set in a subsequent power generation time period. This generation is done simply to be able to supply brief peaks in power need or consumption, at the cost of power potentially being wasted most of the time.

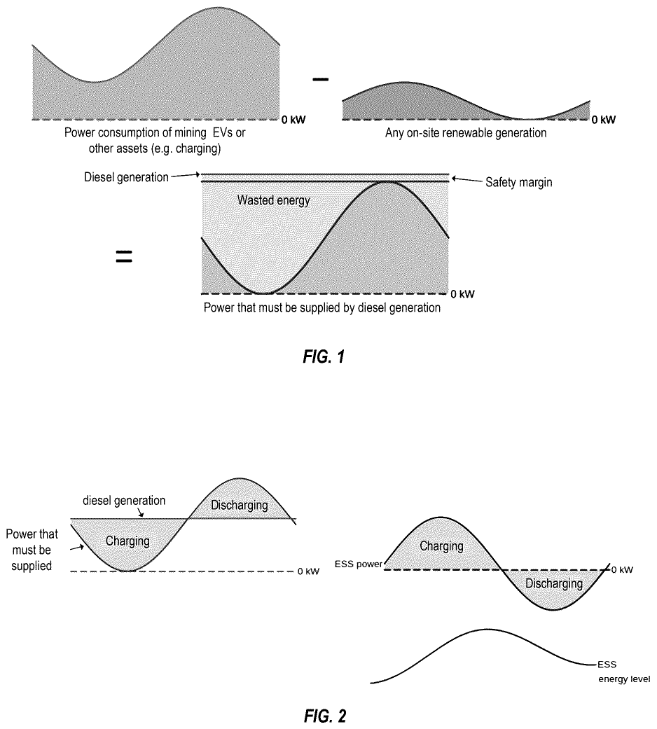

FIG. 1 consists of graphs showing examples of power to be supplied by diesel generation, which may be the consumption of mining assets for charging over time minus some lesser amount of any on-site renewable generation, for example wind or solar. Notice how a peak is shown in the consumption of the assets when the renewable generation happens to temporarily fall to zero. In addition, FIG. 1 shows how the diesel generation must be able to meet the highest amount of power that must be supplied, often plus some safety margin to account for forecasting error in that quantity. This is a waste of fuel and money, and an opportunity to reduce needless GHG emissions.

According to aspects of the present disclosure, systems, devices, and methods are provided for improving the control and efficiencies relating to non-renewable power generation and power consumption, for example by charging of EVs and/or other equipment or assets.

The term “electric vehicle” or EV is used broadly herein for simplicity to include any types of electric assets or battery electric assets, including vehicles, equipment, tools, systems, and any other types of assets. Thus, references to an “electric vehicle(s)” is not limited to only vehicles. Some mere example types of EVs include but are not limited to trucks, cars, dump trucks, haul trucks, loaders, backhoes, mining shovels, drill rigs, feeder breakers, service trucks, crawler carriers, forklifts, roof bolters, boom lifts, deck trucks, personnel carriers, scissor lifts, shotcrete sprayers, emulsion chargers, agitators, water sprayers, autonomous vehicles, and so on.

Teachings according to the present disclosure may be applied and implemented in various different fields and applications. Although various embodiments and examples are described with reference to mining applications, these are merely examples used for ease of description and are thus not limiting. Thus, references herein to mines, mining sites, mining vehicles, mining equipment and other assets, and so on, are not limiting and instead apply to, cover, and include other fields and applications. The present teachings apply to and include other applications where some of the required power, which may be used for charging of electric vehicles or equipment, is generated using non-renewable sources, which may include an on-site non-renewable power generation system. Other example fields and applications include but are not limited to forestry, oil rigs, drilling operations, remote construction projects, and other heavy industrial operations that cannot rely on a potentially unstable grid connection. References to a remote site, such as a remote mine, is used for ease of description to generally refer to any site, which may not be geographically remote, including a site that has insufficient access to power from a source such as a power grid. Insufficient access may mean no access, inadequate access for the demand, insufficiently reliable access, and so on, and any combination thereof.

The term “on-site” generally refers to one or more items being physically located at, or in close proximity, to a site, such as a mining site or any other type of site.

Some techniques and approaches that are implemented in one or more embodiments are now described. Some of the techniques and approaches may be combined in one or more ways.

In at least some embodiments, a power control system generates control information for providing control in relation to EVs, for example to schedule charging of EVs, which may involve optimizing or otherwise scheduling to reduce peaks in charging power demand which may in turn reduce an amount of non-renewable power generation required. Accordingly, a power generation level setpoint for a non-renewable power generation system may be set based on the power requirements for the scheduled EV charging. This setpoint may be assessed at various time intervals and may be adjusted based at least in part on power requirements for the scheduled EV charging in an upcoming time period, for example so that the amount of non-renewable power generation in the period aligns with the amount of power needed to meet power requirements for the scheduled EV charging, subject to a buffer or safety margin, such that there is little or no wasted non-renewable power generation. On the other hand, if the non-renewable power generation is such that its efficiency increases with its power output and its power output can closely track the demand for power, then it can be dispatched in short, high-efficiency bursts, in which case it can be treated, for optimization purposes, like an ESS that can only discharge at maximum power. Many non-renewable generators have a sweet spot setpoint where their efficiency is maximized. In addition, such an assessment may also take into consideration one or more of power generation from other sources such as any renewable sources (e.g. wind, solar, etc.) which may be on-site, and power consumption by any auxiliary loads on-site.

In at least some embodiments, a method or technique of reducing diesel wastage may include accurately predicting or controlling the power that is consumed by EVs at the mine. If the amount of power that will be consumed by EVs can be controlled or otherwise knowable in advance, even approximately, then the amount of diesel generation kept running may be reduced or minimized. For example, if a peak power consumption by EVs is forecasted with a large error, for example of plus or minus 500 kW, then the largest error of +500 kW may be used as the safety margin, resulting in between 0 and 1000 kW of power wasted, not only during the peak, but during the entire period of operation (corresponding to 0-1000 kWh of energy over a 1-hour period). This does not even account for the full amount of off-peak power wasted. Thus, making more accurate forecasts, and optionally having tighter prediction intervals, may reduce energy wastage, cost, and GHG emissions. However, forecasting the needed power for charging of mining EVs is not necessarily trivial as it may need many inputs in order to be accurate. Another method may include optimally controlling EVs at the mine, thereby potentially optimally controlling power consumption of those EVs. Controlling an EV may include controlling or influencing the charging of the EVs, or the operation of the EVs such as the times or schedules for which the EVs are operational (for example working at the mine) and/or are charging.

In at least some embodiments, another method or technique may comprise accurately forecasting the power generated by any on-site renewable sources, for example wind or solar or any other type of renewable generation. A setpoint for an on-site non-renewable power generation system may be based on a prediction of a level of on-site renewable power generation. If there is any renewable generation at the mine, then its forecasted power generation, or some proportion thereof, may be subtracted from a predicted power consumption of EVs at the mine before calculating a minimum amount of diesel generation necessary. While renewable generation cannot be controlled or optimized in a similar manner as the power consumption of EVs can be controlled or optimized, the same or similar benefits of accurate forecasting may apply.

In at least some embodiments, another method or technique may comprise using on-demand dispatching of power to/from an ESS, which may be on-site or not on-site. A setpoint for an on-site non-renewable power generation system may be based on a predicted amount of energy stored in an ESS, for example that could be used for charging. If there is an ESS at the mine, the ESS may be used to store excess energy, for example generated from diesel generation or renewable generation if present. Diesel may provide a base supply of power, and power demand exceeding the base supply may be provided by renewable generation when present and some or all of any shortfall of renewable generation may be met by power from the ESS. FIG. 2 shows the same amount of power required as in FIG. 1, but the setpoint of diesel generation is reduced via strategic use of the ESS. Diesel generation power may be used to charge an ESS when the power generation exceeds the demand. On the other hand, when the amount of power that must be supplied exceeds the diesel generation, then power stored in the ESS may be discharged. The amount of diesel generation and the size of ESS may be minimized by the optimizer according to the present disclosure to avoid the ESS discharging toward zero or charging toward 100% capacity, which may possibly lead to not having enough power or wasting power, respectively. In addition, an ESS may be additionally or alternatively used to supply a higher power demand in the place of some or all of the diesel generation, thereby allowing the amount of diesel generation to be reduced, perhaps to zero given sufficient on-site renewable generation.

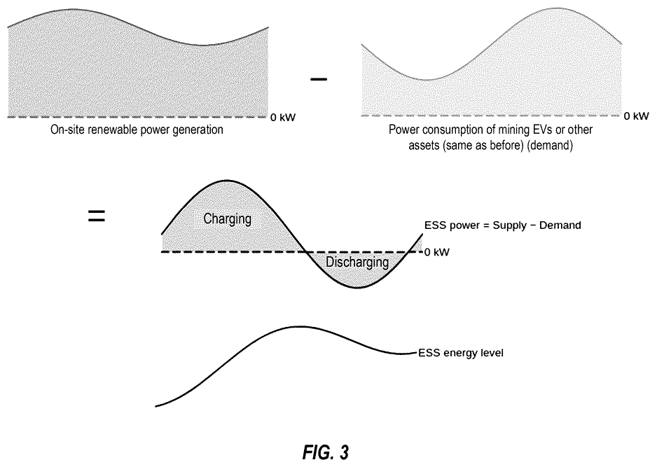

In at least some embodiments, another method or technique, which is related to the above noted method or technique relating to using an ESS, involves supporting an elimination of diesel generation when there is sufficient renewable power generation. An ESS may store renewable energy when there is excess, and later discharge the energy for consumption when there is a deficit of renewable energy generation. In this sense, the ESS may be used for peak shaving between (a) the generation sources and (b) the final consumption of energy by assets at the mine. FIG. 3 shows that even when a large amount of renewable generation is insufficient to supply the consumption by the EVs, extra renewable energy previously stored in an ESS can be discharged to cover part or all of the deficit.

In at least some embodiments, another method or technique may comprise re-adjusting the otherwise constant setpoint of diesel generation at various time intervals, sometimes referred to herein as a power generation time period, for example every 5 minutes, 30 minutes, hour, 2 hours, etc. The setpoint may be reduced in periods when the highest power that must be supplied is lower, potentially saving a lot of diesel.

According to aspects of the present disclosure, systems and methods are provided that reduce or minimize diesel usage and/or diesel wastage for the generation of electrical power at a mine, and more generally that reduce or minimize usage of fuel for non-renewable power generation and/or wastage of fuel in any suitable application. A mine may use a fully-electrified fleet of EVs, or a mixed fleet of EVs and non-electric vehicles or equipment. A system may optimally control how EVs charge over time, and optionally how they discharge, subject to their operating needs, such that the required setpoint of diesel generation is minimized. A system may optimally control a setpoint of non-renewable power generation over time. In some embodiments, the controlling of the charging of EVs and the controlling of non-renewable power generation may be part of the same optimization. Controlling when and how mining EVs charge over time is often subject to one or more constraints such as how much the EVs must charge and when. However, there is often some flexibility in the charging of the EVs, which provides an opportunity for optimization. In some embodiments, the amount of required diesel generation may potentially be reduced to zero if sufficient renewable generation exists, thereby also minimizing wasted diesel generation. In addition, in at least some embodiments, the system may optimize when and/or at what setpoint of power generation one or more diesel generators are set to reduce diesel usage by the generators by using the generators more efficiently, for example only if and to the extent necessary.

Furthermore, in at least some embodiments where there are one or more ESSs, the system may optimize or otherwise control how the ESSs are charged and discharged, for example to store and provide energy to EVs for charging. Furthermore, in at least some embodiments where there is on-site renewable power generation, the system may forecast the on-site renewable power generation. Furthermore, in at least some embodiments where there are on-site auxiliary load(s), which may include any other assets or equipment that consume power at the site such as lighting, heating systems, computers, and so on, the system may forecast the power consumption by the on-site auxiliary loads. The system may use the current and/or forecasted on-site renewable power generation, and/or current and/or forecasted power consumption by the on-site auxiliary loads for generating control information for controlling the EVs or for performing optimizations, and so on. This information provides information relating to how much renewable power is or will be available.

Furthermore, in at least some embodiments, if power from a power grid is available at the site for charging, but only a limited amount of power may be consumed from the power grid, for example due to a limited size of the grid connection, then the system may take this constraint into consideration, for example when it performs optimizations, for example relating to controlling EV charging and/or non-renewable power generation. Furthermore, in at least some embodiments, one objective which may be a primary objective may include minimizing diesel usage or wastage for power generation, and another objective which may be a secondary objective may relate to the system performing peak shaving to reduce the strain on the grid connection and/or to reduce costs of power from the grid, or the system may work to minimize time-of-use (TOU) energy costs or maximize the cleanliness of energy used, or some combination of these.

A power consumption profile of mining EVs as shown in FIG. 1 or FIG. 3 may result from a naive policy wherein EVs are charged at high or maximum power as soon as they plug in, and fully stop charging once the required or desired amount of energy has been delivered. However, if many EVs plug in at a similar time, especially at a time when any renewable generation is low, this may typically create a peak in the amount of power that must be supplied by diesel generation. Without a forecast of such a peak demand, the demand may unacceptably prevent or delay the EVs from being charged. However, forecasting the amount of diesel generation required to cover such a peak, and setting the setpoint of diesel generation to that amount, often means that excess power will be generated before and after the peak, resulting in wastage of diesel.

In at least some embodiments, the charging of mining EVs may be spread out over time to flatten or shave such peaks in overall charging power demand. If there is sufficient renewable generation, the charging of E Vs may be shifted to coincide or at least somewhat align with times of higher renewable generation. This constitutes peak shaving between the diesel generation and the power that must be supplied by the diesel generation. The same or similar results may be achieved by controlling the diesel generation and/or the charging and discharging of an ESS, for example in near real-time. However, this may likely require a larger-than-optimal diesel generation system and/or ESS, thereby increasing the up-front and maintenance costs to mines. In at least some embodiments, a system or method may be implemented, in some cases predominantly in software, which may be more affordable or economical if it avoids or reduces the higher costs associated with acquiring and maintaining larger diesel generators and/or ESSs. Thus, such a system or method may potentially lower a barrier to the electrification of mining vehicles by minimizing or reducing the amount of diesel generation required, minimizing or reducing the amount of ESS that may be required, and/or supporting the replacement of diesel with renewables.

In general, EVs are not available for charging when they are not coupled to a power source, for example electric vehicle supply equipment (EVSE) such as a charger. This is often referred to herein as being unplugged. Chargers may be part of a larger EV charging architecture. Similarly, EVs may be or are available for charging when they are coupled to a power source, which is often referred to herein as being plugged in. When an EV becomes available for charging is sometimes referred to herein as when an EV “arrives”, for example when an EV arrives at a charger, for example at a depot at a mine and so on, and such times are sometimes referred to as “arrival times”. Similarly, when an EV becomes unavailable for charging is sometimes referred to herein as when an EV “departs”, for example when an EV departs a charger, for example at a depot at a mine and so on, and such times are sometimes referred to as “departure times”. The same applies to prediction information relating to arrivals or departures of EVs.

According to an aspect, the present disclosure is directed to a system, comprising a computer-readable storage medium having executable instructions, and one or more computer processors configured to execute the instructions to provide control in relation to charging of a plurality of electric vehicles (EVs), wherein the charging is performed using power received at least in part from an on-site non-renewable power generation system that is separate from a power grid, the instructions to generate charging control information for providing charging control in relation to the EVs, generate non-renewable power generation control information comprising an indication of a power generation setpoint for the on-site non-renewable power generation system, the non-renewable power generation control information being at least partly based on the charging control information, wherein the generating the charging control information and the non-renewable power generation control information comprises performing a receding horizon optimization for an optimization horizon having a plurality of time intervals, the charging control information comprising EV charging schedule information comprising an indication of individual one or more EVs to charge during individual one or more time intervals in the optimization horizon, the optimizing for minimizing fuel consumption by the non-renewable power generation system, wherein the optimizing is based at least on charging goal information relating to at least one EV that is coupled to electric vehicle supply equipment (EVSE) for performing the charging, the charging goal information of an EV comprising information relating to target charging completion time for the EV, and remaining target energy to deliver to the EV by the target charging completion time, provide the charging control information for use by one or more computing devices associated with one or more EVs for use in controlling charging of the one or more EVs, and provide the non-renewable power generation control information for use by one or more computing devices associated with the on-site non-renewable power generation system for use in controlling an amount of power generation of the on-site non-renewable power generation system.

In at least some embodiments, the non-renewable power generation control information is for a first power generation time period, the instructions further to, for a second power generation time period subsequent to the first power generation time period, generate an indication of a new power generation setpoint for the second power generation time period based on generated charging control information for one or more time intervals during the second power generation time period, the new power generation setpoint differing from the power generation setpoint for the first power generation time period.

In at least some embodiments, wherein the on-site non-renewable power generation system comprises a plurality of non-renewable power generators, and wherein the indication of a power generation setpoint for the on-site non-renewable power generation system comprises indications of a power generation setpoint for each of at least two of the plurality of non-renewable power generators.

In at least some embodiments, the indications of a power generation setpoint for each of at least two of the plurality of non-renewable power generators comprises an indication to at least one of: start up at least one of the non-renewable power generators, turn off at least one of the non-renewable power generators, and operate at least one of the non-renewable power generators at a minimum operating power level instead of turning off the non-renewable power generator.

In at least some embodiments, the optimizing comprises performing peak shaving to reduce an overall amount of energy required for charging during a peak shaving time period, the peak shaving comprising generating EV charging schedule information with at least some shifted charging of individual one or more EVs during individual one or more time intervals in the optimization horizon.

In at least some embodiments, the optimization is further based on prediction information relating to predicted on-site renewable power generation during the optimization horizon, wherein at least some of the on-site renewable power is available for EV charging, and wherein the power generation setpoint for the on-site non-renewable power generation system is based on the predicted on-site.

In at least some embodiments, the optimization is further based on prediction information relating to predicted energy available for charging stored in an energy storage system (ESS) during the optimization horizon, and wherein the power generation setpoint for the on-site non-renewable power generation system is based on the predicted energy stored in the ESS.

In at least some embodiments, the optimizing is further based on prediction information relating to EVs predicted to become available for charging during the optimization horizon, the prediction information comprising predicted time an EV becomes available for charging, predicted target charging completion time for the EV, predicted target energy to deliver to the EV by the target charging completion time.

In at least some embodiments, the instructions may be further to control the charging of the one or more EVs based on the charging control information by controlling the operation of EVSE and/or one or more EVs to charge the individual EVs, and control the amount of power generation of the on-site non-renewable power generation system based on the non-renewable power generation control information by setting a power generation setpoint of the on-site non-renewable power generation system.

According to an aspect, the present disclosure is directed to a method comprising at one or more electronic devices each having one or more processors and computer-readable memory, to provide control in relation to charging of a plurality of electric vehicles (EVs), wherein the charging is performed using power received at least in part from an on-site non-renewable power generation system that is separate from a power grid generating charging control information for providing charging control in relation to the EVs, generating non-renewable power generation control information comprising an indication of a power generation setpoint for the on-site non-renewable power generation system, the non-renewable power generation control information being at least partly based on the charging control information, wherein the generating the charging control information and the non-renewable power generation control information comprises performing a receding horizon optimization for an optimization horizon having a plurality of time intervals, the charging control information comprising EV charging schedule information comprising an indication of individual one or more EVs to charge during individual one or more time intervals in the optimization horizon, the optimizing for minimizing fuel consumption by the non-renewable power generation system, wherein the optimizing is based at least on charging goal information relating to at least one EV that is coupled to electric vehicle supply equipment (EVSE) for performing the charging, the charging goal information of an EV comprising information relating to target charging completion time for the EV, and remaining target energy to deliver to the EV by the target charging completion time, providing the charging control information for use by one or more computing devices associated with one or more EVs for use in controlling charging of the one or more EVs, and providing the non-renewable power generation control information for use by one or more computing devices associated with the on-site non-renewable power generation system for use in controlling an amount of power generation of the on-site non-renewable power generation system.

In at least some embodiments, the non-renewable power generation control information is for a first power generation time period, the method further comprising, for a second power generation time period subsequent to the first power generation time period, generating an indication of a new power generation setpoint for the second power generation time period based on generated charging control information for one or more time intervals during the second power generation time period, the new power generation setpoint differing from the power generation setpoint for the first power generation time period.

In at least some embodiments, the on-site non-renewable power generation system comprises a plurality of non-renewable power generators, and wherein the indication of a power generation setpoint for the on-site non-renewable power generation system comprises indications of a power generation setpoint for each of at least two of the plurality of non-renewable power generators.

In at least some embodiments, the indications of a power generation setpoint for each of at least two of the plurality of non-renewable power generators comprises an indication to at least one of start up at least one of the non-renewable power generators, turn off at least one of the non-renewable power generators, and operate at least one of the non-renewable power generators at a minimum operating power level instead of turning off the non-renewable power generator.

In at least some embodiments, the optimizing comprises performing peak shaving to reduce an overall amount of energy required for charging during a peak shaving time period, the peak shaving comprising generating EV charging schedule information with at least some shifted charging of individual one or more EVs during individual one or more time intervals in the optimization horizon.

In at least some embodiments, the optimization is further based on prediction information relating to predicted on-site renewable power generation during the optimization horizon, wherein at least some of the on-site renewable power is available for EV charging, and wherein the power generation setpoint for the on-site non-renewable power generation system is based on the predicted on-site renewable power generation.

In at least some embodiments, the optimization is further based on prediction information relating to predicted energy available for charging stored in an energy storage system (ESS) during the optimization horizon, and wherein the power generation setpoint for the on-site non-renewable power generation system is based on the predicted energy stored in the ESS.

In at least some embodiments, the optimizing is further based on prediction information relating to EVs predicted to become available for charging during the optimization horizon, the prediction information comprising predicted time an EV becomes available for charging, predicted target charging completion time for the EV, predicted target energy to deliver to the EV by the target charging completion time.

In at least some embodiments, the method further comprises controlling the charging of the one or more EVs based on the charging control information by controlling the operation of EVSE and/or one or more EVs to charge the individual EVs, and controlling the amount of power generation of the on-site non-renewable power generation system based on the non-renewable power generation control information by setting a power generation setpoint of the on-site non-renewable power generation system.

According to an aspect, the present disclosure is directed to a non-transitory computer-readable medium having computer-readable instructions stored thereon, the computer-readable instructions executable by at least one processor to cause the performance of operations relating to providing control in relation to charging of a plurality of electric vehicles (EVs), wherein the charging is performed using power received at least in part from an on-site non-renewable power generation system that is separate from a power grid, the operations comprising generating charging control information for providing charging control in relation to the EVs, generating non-renewable power generation control information comprising an indication of a power generation setpoint for the on-site non-renewable power generation system, the non-renewable power generation control information being at least partly based on the charging control information, wherein the generating the charging control information and the non-renewable power generation control information comprises performing a receding horizon optimization for an optimization horizon having a plurality of time intervals, the charging control information comprising EV charging schedule information comprising an indication of individual one or more EVs to charge during individual one or more time intervals in the optimization horizon, the optimizing for minimizing fuel consumption by the non-renewable power generation system, wherein the optimizing is based at least on charging goal information relating to at least one EV that is coupled to electric vehicle supply equipment (EVSE) for performing the charging, the charging goal information of an EV comprising information relating to target charging completion time for the EV, and remaining target energy to deliver to the EV by the target charging completion time, providing the charging control information for use by one or more computing devices associated with one or more EVs for use in controlling charging of the one or more EVs; and providing the non-renewable power generation control information for use by one or more computing devices associated with the on-site non-renewable power generation system for use in controlling an amount of power generation of the on-site non-renewable power generation system.

In at least some embodiments, the non-renewable power generation control information is for a first power generation time period, the method further comprising, for a second power generation time period subsequent to the first power generation time period, generating an indication of a new power generation setpoint for the second power generation time period based on generated charging control information for one or more time intervals during the second power generation time period, the new power generation setpoint differing from the power generation setpoint for the first power generation time period.

In at least some embodiments, the charging may be performed using power received at least in part from a non-renewable power generation system which is not on-site. For example, a non-renewable power generation system may be located remotely from the site.

In at least some embodiments, generating charging control information and non-renewable power generation control information may comprise or be based on a receding horizon having a plurality of time intervals. The charging control information may comprise EV charging schedule information comprising an indication of individual one or more EVs to charge during individual one or more time intervals in the horizon, the generating the charging control information and the non-renewable power generation control information for minimizing fuel consumption by the non-renewable power generation system, wherein the generating the charging control information and/or the non-renewable power generation control information is based at least on charging goal information relating to at least one EV that is coupled to electric vehicle supply equipment (EVSE) for performing the charging.

In at least some embodiments, the generating the charging control information and the non-renewable power generation control information involves peak shaving to reduce an overall amount of energy required for charging during a peak shaving time period, the peak shaving comprising generating EV charging schedule information with at least some shifted charging of individual one or more EVs during individual one or more time intervals in the horizon.

In at least some embodiments, the generating the charging control information and the non-renewable power generation control information is further based on prediction information relating to predicted on-site renewable power generation during the horizon, wherein at least some of the on-site renewable power is available for EV charging, and wherein the power generation setpoint for the on-site non-renewable power generation system is based on the predicted on-site renewable power generation.

In at least some embodiments, the generating the charging control information and the non-renewable power generation control information is further based on prediction information relating to predicted energy available for charging stored in an energy storage system (ESS) during the horizon, and wherein the power generation setpoint for the on-site non-renewable power generation system is based on the predicted energy stored in the ESS.

In at least some embodiments, the generating the charging control information and the non-renewable power generation control information is further based on prediction information relating to EVs predicted to become available for charging during the horizon, the prediction information comprising at least one of predicted time an EV becomes available for charging, predicted target charging completion time for the EV, and predicted target energy to deliver to the EV by the target charging completion time.

In at least some embodiments, the indication of a power generation setpoint for the on-site non-renewable power generation system during a first power generation time period comprises an indication to adjust an amount of power generation for the on-site non-renewable power generation system from a first non-zero power setpoint to a different second non-zero power setpoint. For example, a power setpoint of the generator system may be adjusted between different power generation setpoints, both of which are non-zero, which may exclude the scenario of simply turning a generator between on and off.

In at least some embodiments, the charging control information includes charging rate information for charging of individual one or more EVs during individual one or more time intervals in the optimization horizon. For example, control information may include a charging rate(s) to use during the time interval for charging of individual EVs.

In at least some embodiments, the charging control information comprises information indicating at least one assignment of a specific EV to a specific EVSE.

In at least some embodiments, the optimizing, or generating the charging control information and the non-renewable power generation control information, further includes generating control information for charging or discharging an energy storage system (ESS) during one or more time intervals in the optimization horizon, wherein the ESS charging comprises using at least some otherwise unused power from the non-renewable power generation system, and wherein the ESS discharging comprises providing energy for EV charging when there is insufficient power from the non-renewable power generation system. For example, an ESS may be used by charging using excess diesel generation and discharging when there is insufficient diesel generation.

In at least some embodiments, the optimization, or generating the charging control information and the non-renewable power generation control information, is further based on prediction information relating to predicted on-site auxiliary power load during the optimization horizon, and wherein the power generation setpoint for the on-site non-renewable power generation system is based on the predicted on-site auxiliary power load. For example, a prediction of on-site auxiliary power load may be used for setting an amount of non-renewable power generation.

In at least some embodiments, the EVs comprise at least some mining EVs.

In at least some embodiments, the on-site non-renewable power generation system comprises one or more fossil fuel generators.

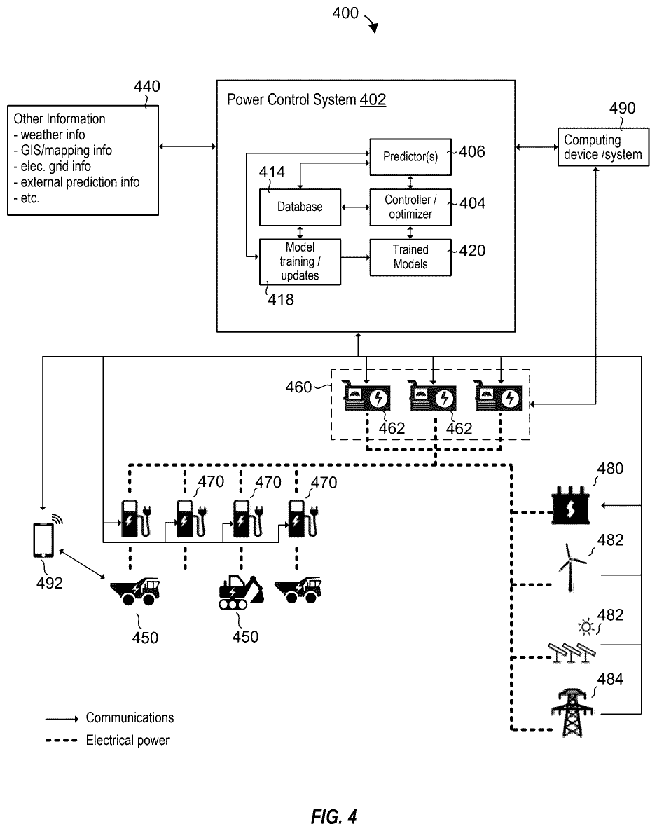

FIG. 4 is a block diagram of an example system 400 comprising a power control system 402, a plurality of EVs 450, and a non-renewable power generation system 460. System 400 is described in relation to an example and non-limiting application of mining at a mining site, where at least some of the EVs are mining EVs or other electric mining assets. Non-renewable power generation system 460 may be an on-site system, generally meaning located at the mining site. Non-renewable power generation system 460 may be separate from a power grid, meaning that power generated by system 460 is separate from power provided by a power grid. Power control system 402 may receive information as input, hereinafter input information, and may generate control information for providing control in relation to assets, for example in relation to the charging of mining EVs 450, to the generation of power by non-renewable power generation system 460, to the charging and discharging of ESS 480, and so on. Power control system 402 may attempt to reduce or minimize an amount of fuel that is used to generate power by non-renewable power generation system 460. The generating of control information may involve performing one or more optimizations in relation to one or more optimization objectives, for example the previously noted minimizing an amount of fuel that is used by a non-renewable power generation system.

Power control system 402 may communicate with one or more other components, including those shown in FIG. 4 such as EVs 450, non-renewable power generation system 460, chargers 470, ESS 480, any sources of renewable power generation 482, a power grid 484, computing devices or systems 490, 492, sources of information 440, and so on, in any suitable ways, including over any suitable communication channel, connection, or network, which may be wired or wireless, and which may include the Internet. In general, for simplicity, references herein to the internet include other communication networks and communication channels other than the internet. Furthermore, FIG. 4 shows some example data or signal connections between components or subsystems in solid lines, and also shows some example electrical power connections in dashed lines.

Power control system 402 may comprise one or more of a controller 404, which may generally provide control in relation to EVs 450 and/or any other assets, one or more predictors 406, a database 414 for storing any suitable information, one or more model training modules 418, for example to train an optimizer model for controller 404 or a predictor model for predictor 406, and a trained models module 420 for storing trained models. In general, a machine learning model is generated or trained using one or more machine learning algorithms.

Controller 404 may use information as input and generate control information for providing control in relation to assets in the system, for example EVs 450, non-renewable power generation system 460, and/or other assets. Controller 404 may comprise one or more optimizers for optimizing in relation to one or more objectives. The optimizer may optimize with respect to an aspect of how the EVs or other assets operate toward one or more objectives. An objective may include minimizing fuel consumption by non-renewable power generation system 460, or minimizing power generation by non-renewable power generation system 460. Some other example types of objectives include minimizing carbon emissions due to EV charging, minimizing usage of power from a power grid, and so on. In general, an optimizer may take any suitable form, and be or include any suitable module, program, machine, subsystem, algorithm, technique, and so on, that is configured to perform some kind of optimization(s) or improvement(s) in relation to one or more objectives.

Minimizing non-renewable power generation and minimizing fuel consumption by a non-renewable power generator are related but not necessarily the same objectives. Power generation is a function of fuel consumption. Minimizing power generation at a given time will also minimize the fuel consumption. However, if a generator becomes more efficient at high power, it may be operated for short, efficient bursts. During a burst, power generation and fuel consumption may be maximized, not minimized. But in this case, if the average power consumption over time is the same, the average fuel consumption may be less because the fuel is consumed at times when it is consumed at a higher efficiency.

In at least some embodiments, the control information may include one or more of information relating to if and when to charge EVs, information relating to a charging rate to be used for charging one or more EVs, and information relating to if and/or when to discharge EVs when the EVs and EVSE support vehicle-to-grid (V2G) or V2G-like capabilities where the discharged power could be used to power other assets at the mining site. The control information may relate to currently-plugged-in mining EVs, and/or to currently-plugged-in mining EVs and EVs that are predicted or expected to plug-in in the near future for example during an optimization horizon. In some embodiments, the charging control information may comprise EV charging schedule information comprising an indication of individual one or more EVs to charge during individual one or more time intervals in the optimization horizon.

In at least some embodiments, the control information may include information relating to an indication of a power generation setpoint for the on-site non-renewable power generation system. The control information may relate to this setpoint generally and/or may include control information more specific to individual generators in the non-renewable power generation system. In at least some embodiments, the non-renewable power generation control information is at least partly based on the charging control information. For example, if peak shaving is successfully done by adjusting the EV charging and ESS charging/discharging, then a lower setpoint can be selected and set for the non-renewable power generation.

In at least some embodiments comprising one or more ESS(s), the control information may include information relating to if and when to charge and discharge the ESSs. In some embodiments, the control information may include information relating to a rate at which to charge or discharge each ESS.

One or more of the types of control information may be considered equivalent to deciding when to charge/discharge each asset, in at least some embodiments.

In at least some embodiments, controller 404 may not be in direct control of certain parameters of various assets, for example a power level of each asset. For example, controller 404 may only be able to toggle between charging, for example at a power limit, and not charging EVs, which may depend on constraints such as those imposed by the chargers or EVSE. As another example, an ESS may only be controllable by setting energy thresholds below or above which to charge or discharge, respectively, and this may be a constraint which may be imposed internally at the ESS, for example by an internal controller of the ESS.

Furthermore, in at least some embodiments, the control information may include information relating to when to operate (for example to perform work at the mine) versus when to plug-in and potentially charge individual EVs, which may essentially optimize the schedules of the EVs.

In at least some embodiments, controller 404 may implement a Model Predictive Control (MPC) loop to recurrently take new actions based on updated optimal decisions, which may in turn be based on updated input information. Again, input information may comprise information that is or was observed and/or may be predicted by a predictor. A Model Predictive Control may form a feedback loop wherein updated or current information, for example energy or SOC levels of EVs, power levels, or any other information relating to any assets, which may include information as a result of actions taken by the system 402, may be fed back into the system 402.

In addition, power control system 402 may comprise one or more predictors 406 that generate prediction information of any suitable types. Prediction information may be used by controller 404 to generate control information for providing control in relation to EVs 450 and/or any other assets.

Control may include providing control information for use by EVs 450 or other assets, chargers, or other components. Control information may include actions to be taken by the assets, or recommendations for actions to the assets. For ease of reference, actions or recommendations may be referred to collectively herein simply as “actions” but is to be interpreted to include both unless indicated otherwise or results in some obvious inconsistency. The control information may comprise instructions to be followed, recommendations to be considered, and/or options or other parameters that may be selected, toggled, adjusted, inputted, and so on.

The degree that power control system 402 may have in directly controlling assets may depend on whether and how control may be provided, for example to or through EVs, EVSE, non-renewable power generation system, ESS controllers, or any other interfacing technologies. Example actions or recommendations include EV charging schedule information, which may include indications for specific EVs relating to one or more of when to charge and/or not to charge (for example at a specific time or during a time period or interval), how to charge (for example a charging rate), where to charge (for example an identification or indication of a specific charger or a specific geographic area known or assumed to have one or more chargers), if or when or how to use energy stored in some EVs to charge other EVs, and so on. In addition, an action may involve setting or adjusting a setpoint of a non-renewable power generation system or of one or more non-renewable power generators in such a system, which may include turning on a generator or turning off a generator, and so on. In addition, an action may include one or more of starting up at least one of the non-renewable power generators, turning off at least one of the non-renewable power generators, and operating at least one of the non-renewable power generators at a minimum operating power level instead of turning off the non-renewable power generator. The executing or triggering of actions may be partially or fully automatic, meaning without any human intervention.

Control information may be provided to, or for use by, the assets themselves where the assets have an internal or associated computing device or system for receiving and implementing actions indicated by the control information. For an example, control information may be provided to a computing device or system of an EV 450, a charger 470, non-renewable power generation system 460, an ESS 480 and so on. In addition or alternatively, control information may be provided to, or for use by, computing devices 490, 492 that may be associated with specific assets, for example mobile device 492 associated with a driver or operator of an EV 450, or a computing device 490 associated with non-renewable power generation system 460, and so on. A device associated with an asset may instruct or otherwise cause the asset to implement the action, or the device may output information which may be received by a person who may then take action to cause the asset to implement the action. For example, the device may display a power generation setpoint and the person may then take action to cause a non-renewable power generation system to be set at the indicated setpoint, and so on.

The term “connector” is used herein to refer a physical interface of EVSE that connects the EVSE with an EV. The term “charger” is used herein to generally refer to a single EVSE, which may have one or more connectors. Charging instructions may direct EVs to charge at a specific connector or charger, or to charge in a region without directly specifying the charger or connector to be used.

Input information to power control system 402 may include any suitable types of information from any suitable sources.

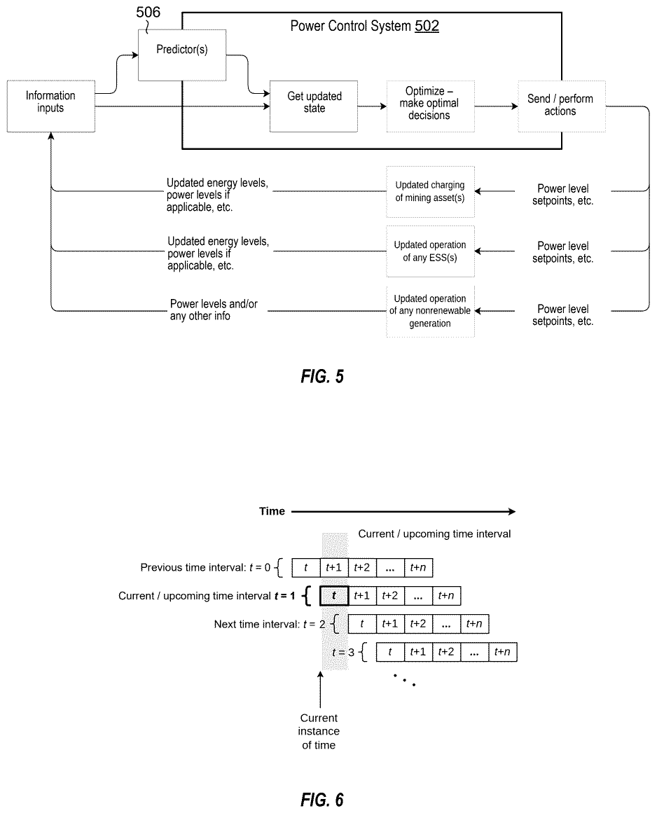

FIG. 5 is a block diagram of an example configuration and process showing some example types of inputs and actions or other operations in relation to a power control system 502 according to the present disclosure. Power control system 502 may get an updated state of the system, which may comprise the various assets, based on input information, which may include information relating to any of the assets, for example from mining EVs or assets, ESS(s), or non-renewable power generation systems. Input information may also include prediction information which may be generated by one or more predictors 506 of power control system 502 and/or externally of power control system 502. Power control system 502 may perform one or more optimization based on the state information, which may generally include the various input information. The outcome of the optimization may be used as, or to generate, control information for providing control in relation to the assets. Control information is illustrated as including setpoints, but may include any types of suitable information. A power level setpoint for an EV may relate to a charging level (for example electrical current). A power level setpoint for an ESS may relate to a charging rate or discharging rate of the ESS. A power level setpoint for a non-renewable power generation system may relate to a setpoint for the entire non-renewable power generation system or for a specific generator. Updated information from the assets may then be provided to power control system 502 as input information, for example for a subsequent optimization, and so on. The updated information may include, for example, updated energy levels, or updated power levels, and so on.

Referring again to FIG. 4, inputs to power control system 402, which may include controller 404, and possibly also predictors 406, may include any suitable types of information from any suitable sources. Input information may relate to any assets, for example EVs 450, non-renewable power generation system 460, electric chargers 470, any ESS 480 which may be on-site, any sources of renewable power generation 482 such as but not limited to solar or wind, which may be on-site. Additionally, input information may relate to power available from a power grid 484.

Example types of input information includes information relating to EVs 450, which may include EV battery state of charge (SOC) information, location information of EVs, whether EVs are idle or are operating, target charging completion time for an EV, target energy desired by the EV, remaining target energy to deliver to the EV by the target charging completion time, and so on. In addition, these types and other types of input information may include prediction information related to EVs, for example predicted SOC information, and so on.

A SOC of a battery, or of a battery cell, generally refers to an energy level that is currently available from the battery as a function or percentage of the maximum capacity of the battery. Thus, a SOC value may vary between 0% and 100%. A battery is said to be fully charged when the SOC is at 100%, and a battery is said to be completely discharged when the SOC is 0%. An absolute (meaning not a ratio) amount of remaining energy in a battery may be calculated by multiplying the SOC value against the maximum capacity of the battery. In addition, SOC may generally indicate or relate to any parameter or value representing, or indicating, an energy level of a battery. For example, SOC information may comprise or consist of the energy level of a battery, which may be represented in a unit of energy (for example kWh).

In some embodiments, input information may include, for each mining EV that is currently plugged-in or charging, one or more of a remaining amount of energy desired, a charging rate, and a target departure or charging completing time. These types of information may be referred to as charging goal information. An amount of energy desired for an EV may include a remaining target energy to deliver to the EV by the target charging completion time. A target charging completion or departure time for an EV may refer to a time by which the EV should be sufficiently charged, for example a time at which the EV is scheduled to depart to begin operating at the mine or a time at which it is simply desired that the EV be sufficiently charged. An amount of energy to be delivered to an EV may be defined or specified in any way, for example by the battery capacity, desired SOC, and/or current or arrival SOC. In some embodiments, whether the current SOC versus arrival SOC may be used may depend on whether the EV is currently charging or expected to plug in to charge within the optimization horizon, respectively. An amount of desired power may be specified in any way, for example by a setting in a system, a setting in a charging schedule, by input from a user, and so on.

In some embodiments, input information may include, for each mining EV that is expected or predicted to plug in to charge within the optimization horizon, one or more of a predicted arrival time at the charger (or more generally a time when an EV becomes available for charging), a predicted amount of energy desired, a predicted target charging completion time, a charging rate, predicted target energy to deliver to the EV by the target charging completion time, and a target departure time.

In some embodiments, input information may include information relating to EVs that are currently plugged-in and to information relating to EVs that are expected or predicted to plug in later on, for example during an optimization horizon. At least some of the input information may include predicted information, for example amount of energy desired, target departure or completion time, and so on. In addition, some of the input information may be treated as hard optimization constraints, for example on delivering the required amount of energy to each asset before its target completion time. Alternatively, some of the input information may be treated as soft constraints and incorporated into or as an optimization objective, wherein the controller may attempt to deliver as much of the desired amount of energy as possible. In some embodiments, the optimizer may decide to sacrifice the delivery of some desired energy to EVs to help minimize usage of non-renewable fuel or minimize the generation of non-renewable power.

In some embodiments, input information may include constraints or limits of the electrical infrastructure at the mine, such as any grid connection.

In some embodiments, input information may include current values and/or forecasts, for example over the optimization horizon, of any on-site renewable generation and/or any auxiliary loads such as energy to power the on-site facility or computing/telecommunication equipment.

Furthermore, in some embodiments, input information may include information relating to one or more of the following: specifications of each EV or other asset, such as battery capacity, compatibility with EVSE, vehicle type, battery health; specifications of the EVSE; specifications of each generator of the on-site non-renewable power generation system, for example diesel generators, such as efficiency curves or how long it takes to start or stop each generator.

By using at least some of the above types of input information, the optimizer takes into account at least some operating needs, schedules, and so on of mining EVs and other assets.

Example types of input information relating to non-renewable power generation system 460 may include or relate to its maximum power output, efficiency curve, duty cycle, etc.

Example types of input information relating to chargers 470 may include or relate to their maximum power, their connectors' maximum powers, which power setpoints are accepted, whether each charger can deliver power through all of its connectors (if more than one) at the same time or one at a time, etc.

Example types of input information relating to one or more ESSs 480 may include or relate to its maximum power, its energy capacity, its SOC operating range, etc.

Example types of input information relating to renewable power generators 482 may include or relate to its maximum power output or how it varies with environmental conditions.

Example types of input information relating to power from a power grid 484 may include or relate to the cost of electricity depending on the time of day, on the time of year, on the peak amount of power consumed in a month, etc.

Input information may include one or more of historical information, current information, and prediction information.

Prediction information may include information from predictor 406 and/or external or third party prediction information (for example weather forecasts from a weather service, and so on). Predictors 406 may use information to make additional data or information, for example time series forecasts, available to the controller 404.

In addition, other examples of input information may include other information 440 which may include, for example and without limitation, information relating to current and/or predicted weather information, information relating to a power grid, Geographic Information System (GIS) information or other mapping data, environmental data, contextual data, and so on.

FIG. 6 is a diagram illustrating an example of a receding-horizon optimization scheme. Power control system 402 may use a receding-horizon optimization scheme, for example where optimizer 404 may generate control information for each time interval between the current time and a horizon of time into the future, thereby following a receding-horizon scheme which may be defined by the duration of each time interval and the duration between the current time and the time horizon. As such, optimizer 404 may plan ahead by making decisions for every future time interval (or time block) in the horizon, although the system may only be able to act on decisions made for the current time interval. With each subsequent time interval, another iteration of optimizer 404 may run with an optimization horizon shifted into the future by a corresponding time interval. FIG. 6 shows subsequent optimization horizons spanning from a time t to time t+n (where the horizon is n time intervals in length) for optimizer iterations at time t=0, 1, 2, 3, etc. In a receding-horizon scheme, an optimizer is able to plan ahead based on the best or latest available information about what will happen in the future. As the next time interval becomes the current time interval, the control or optimization is performed again and can take advantage of information that has become observed rather than predicted, and potentially more accurate predictions that have since been made. The iterative process may repeat indefinitely, thereby making use of the best or latest available information at the time while only taking actions for the time interval between iterations.

As a mere example, control information may be generated for the next hour, 24 hours, 48 hours, one week, or at any other values, at a resolution of 30 minutes, 1 hour, 4 hours, 12 hours, or at any other values. For instance, control information may be generated for the next 7 days and may include control information for each 4 hour period within the 7 day horizon. Control information may be generated for some or all EVs or other assets in each time interval in a time horizon, and the control information may be updated in the next time interval, and so on.

Referring again to FIG. 4, power control system 402, for example controller or optimizer 404 that generates control information may benefit from using not only current or real-time information or historical information, but also prediction information. Prediction information, which may include prediction information generated by predictor 406 and/or prediction information external to system 402, may be provided as input to controller 404 with a potential goal of improving the accuracy of the optimizations or improving other control decisions.

Predictor 406 may generate prediction information, which may be provided to controller 404. Predictor 406 may generate prediction information of any suitable types, for example predictions relating to one or more of source(s) and/or amounts of on-site renewable generation; types and/or amounts of auxiliary load(s); energy score information, for example if an objective of system 402 includes maximizing an energy score; and/or time-of-use (TOU) energy price, which could be in the form of in dollars per kWh if an objective of system 402 includes minimizing the total TOU energy cost.

An energy score may be a metric, which may generally indicate or correspond to one or more properties of energy available from a particular source or type of source. Example properties may relate to, for example, how “green” the energy from a source may be, such as based on the amount of emissions generated to produce and deliver the energy, or an amount of the energy is generated using renewable sources, and so on. Thus, in at least some embodiments, a higher score may indicate a higher suitability of the energy in relation to a given property, such as how “green” it is. A score may take any suitable form, for example a numerical format. Score information may be related to a specific time or time period. Score information may be used to generate and provide control in relation to assets, for example for providing control in relation to one or more of their operations.

In addition, predictor 406 may generate, for each mining EV that is currently charging, prediction information relating to one or more of a remaining amount of energy to be delivered to the EV, and a target departure time of the EV from the charger, for example to resume mining activities. In addition, prediction information may be generated relating to any EVs that are predicted to arrive during an optimization horizon, including for example, for each mining asset that will plug in to charge within an optimization horizon, one or more of an arrival time of the EV at a charger, an amount of energy to be delivered to the EV, and a target departure time of the EV.

Prediction information may have the form of time series data or information.

Controller 404 may generate control information for providing control in relation to assets, for example in relation to the charging of mining EVs 450 and/or the generation of power by non-renewable power generation system 460. In addition, control information may be for providing control in relation to one or more of chargers 470, ESS 480, any sources of renewable power generation 482, and power grid 484.

In general, an optimization problem is typically defined by one or more decision variables, one or more objective functions, and possibly constraints and bounds on the decision variables. An optimization is generally performed in relation to one or more objectives, and the optimization may determine one or more optimal solutions to the problem. A solution to an optimization problem typically consists of numerical value(s) chosen, by means of optimization, for each decision variable. The results of an optimization may be, or may be used to generate, the control information for providing control in relation to assets in the system. Control information may be generally referred to as output of optimizer or controller 404.

In at least some embodiments, the optimizer may perform multi-objective optimization where the objectives are conflicting or inconsistent, in which case the optimization may be configured, for example by a system operator or otherwise, by choosing which of the objectives should be favored by the optimization and by how much, or the objectives may be multiplied by subjective weightings and consolidated (for example summed).

In at least some embodiments, an optimizer may generate a solution that specifies when to charge individual E Vs and/or an amount of power to deliver to each EV, for example based on operating needs of the EVs. For example, a mine may specify that certain types and numbers of EVs are to be operating according to a schedule, which may serve as hard or soft constraints in an optimization.

An optimizer may solve an optimization problem using any suitable approaches or techniques, including traditional mathematical approaches, machine learning (ML) based techniques, reinforcement learning (RL) based techniques, and so on. An optimizer in a receding-horizon optimization may be configured with the horizon and time resolution in which it is to plan ahead. If the optimization problem is a linear programming (LP) problem, a more traditional optimizer might use a dedicated LP solver, but any solver suitable for the problem may be used. If the optimizer has more than one objective, then it can be configured with weights with which to combine them into one objective to optimize for. An RL-based optimizer may use an artificial neural network trained in a simulated environment using any appropriate algorithm, such as Q-learning or proximal policy optimization, and any appropriate data, such as historically observed or synthetically generated EV schedules, renewable generation, etc.

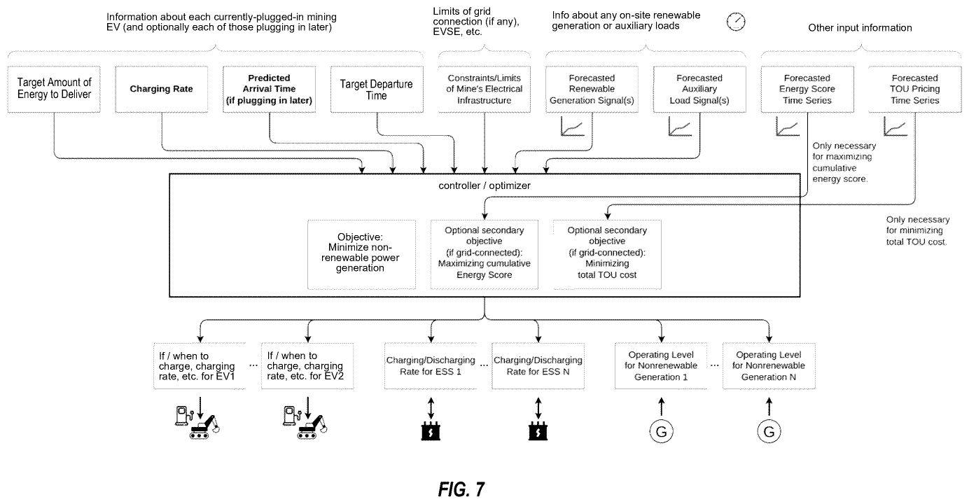

FIG. 7 is a block diagram showing a representation of an example system with example optimization objectives, and inputs and outputs of a controller/optimizer of a power control system. The blocks, arrows, text, and configurations and arrangements in FIG. 7 are examples only and are not limiting.

Again, a controller (e.g. controller 404 of FIG. 4) may generate and output control information. The control information may comprise values from, based on, or relating to one or more solutions generated by the optimizer of controller 404. The optimizer may determine or decide on values for optimization outputs (which may be decision variables in the optimization) for use in optimally controlling assets that can be controlled. Control information may comprise information for providing control in relation to one or more assets, such as EVs, a non-renewable power generation system, one or more ESSs, and so on. In at least some embodiments, the generating of control information by controller 404, such as charging control information and non-renewable power generation control information, may comprise performing a receding horizon optimization for an optimization horizon having a plurality of time intervals. Thus, the decision variables may be decided not only for the current time or until the next iteration of the optimizer runs, but also over the course of the optimization horizon. In this sense, the optimizer plans ahead but may only have decisions executed for the current time interval or period.

In some embodiments, control information relating to charging of EVs or other assets is referred to as charging control information and control information relating to control of a non-renewable power generation system is referred to as non-renewable power generation control information.

Prediction information may be provided, for example, directly as output of one of the predictors of the power control system, may be provided as external information and thus inputted to power control system, and/or may be inherently modeled by the optimizer, for example if the optimizer is ML- or RL-based, thereby inherently including a predictive behavior, as a result of its training on historically observed values of the information being predicted.

Some example optimization objectives for an optimizer of the power control system are now described. Some example objectives have already been mentioned.

Some example objectives include minimizing an amount of power generation by a non-renewable power generation system, minimizing an amount of fuel (for example diesel) used by a non-renewable power generation system, minimizing fuel wastage, and so on. Minimizing fuel usage may be the same or similar to minimizing non-renewable power generation. In at least some embodiments, a primary objective includes minimizing an amount of power generation by a non-renewable power generation system. For simplicity of discussion, but without any limitation, such an objective is sometimes referred to as reducing diesel usage (for generating power).

Some other example objectives, which may potentially be configured to be secondary objectives in an optimization, include minimizing carbon emissions associated with power used, minimizing usage of power from a power grid, maximizing an amount of clean energy used for charging over time, maximizing an energy score, minimizing cost of power from a grid, minimizing cost of power from a grid based on time-of-use (TOU) energy pricing, and minimizing a strain on a grid connection.

In at least some embodiments, to minimize diesel usage, an optimizer may perform peak shaving between the diesel generation and the power that must be supplied by the diesel generation. Peak shaving shifts the power that must be supplied by the diesel generation to evenly distribute it over time or “flatten” it. Peak shaving may be done by minimizing the highest peak(s) that would have to be supplied by diesel over the optimization horizon. Peak shaving may also be performed by minimizing the sum of squares of the amount of power that would have to be supplied by diesel over the optimization horizon, which penalizes peaks and thus encourages the even distribution of power over time. Without optimization, peaks may occur, for example, if many mining EVs plug-in and charge at approximately the same time, if on-site renewable generation suddenly drops, or if there is a spike in an auxiliary load, and so on. Peak shaving may consist of generating EV charging schedule information with at least some shifted charging of one or more EVs during one or more time intervals in an optimization horizon.

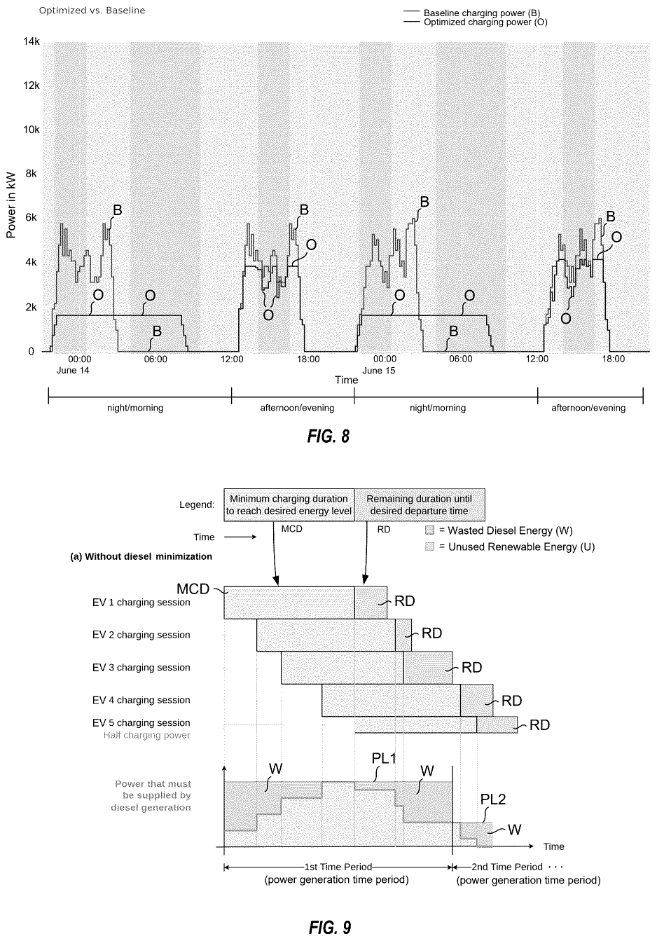

FIG. 8 is an example of peak shaving showing non-optimized, or baseline, (red line—B) versus optimized (blue line—O) charging power simulated for two days for a fleet of mining EVs subject to constraints such as when the vehicles are plugged-in and how much energy needs to be delivered. Each EV is plugged-in twice a day, resulting in a total of four ‘clusters’shown. There is no renewable generation or auxiliary load. With peak shaving, applied separately to each half-day, resulting in four distinct plateau values, the peaks are reduced compared to the non-optimized charging load.

During the afternoon/evening time periods shown, the highest charging load (peak) is reduced a bit. During the night/morning periods, the peaks are reduced notably. This presents an opportunity to provision a mine with smaller or fewer diesel generators, and to run them at a significantly lower setpoint, particularly in the night/mornings and if they are under automatic control of the system. Between the night/morning and afternoon/evening charging periods (just as prior to optimization), the generators may be shut off.

Several examples of optimizations with an objective of minimizing an amount of power generation by a non-renewable power generation system are now described. A minimization of diesel generation, and thus minimization of diesel wastage, may be done by optimizing the charging of mining EVs and, in some embodiments where ESS(s) are present, by optimizing the charging/discharging of the ESS. Again, the mentions of diesel and diesel generation and so on in the present disclosure are only for ease of description and include any types of non-renewable power generation and non-renewable fuels.

FIG. 9 is an example timing diagram showing an example of a non-optimized case showing charging sessions for five mining EVs, including when they plug in, their target time of departure, and how long they must charge to reach their desired or target energy level. The diagram represents a naive policy wherein assets are charged at maximum power as soon as they plug in, and fully stop charging once the required amount of energy has been delivered.

The combined power consumption of the five EVs, which here is also the power that must be supplied by diesel generation, is also shown. Furthermore, the timespan for which the example is shown is divided into a 1st time period and a 2nd time period, which are a first power generation time period and a second power generation time period. Although, it is to be appreciated that the example shows only 2 time periods for simplicity but that in practice there could be many more power generation time periods spanning a much longer overall time of operation. Using the first power generation time period as an example, there is a high and somewhat narrow peak in power demand such that the setpoint of the non-renewable (e.g., diesel) power generation system is set to power level setpoint 1 (PL1), resulting in much diesel energy being wasted. This presents an opportunity for optimization to minimize diesel usage and wastage. In addition, the amount of power that must be supplied by diesel generation in the second power generation time period is lower than in the first time period, and the setpoint in the second power generation time period is set to power level setpoint 2 (PL2).

As shown in this example, a power generation time period may comprise several time intervals of an optimization horizon. Although, a power generation time period may be defined in any other way and need not necessarily align with one or more time intervals in an optimization horizon.

In some embodiments, a controller of the power control system may generate an indication of a new setpoint for the second power generation time period based on generated charging control information for one or more time intervals during the second power generation time period. The new setpoint may differ from the setpoint for the first power generation time period, meaning the setpoint is adjusted relative to the first power generation period. The adjustment of a setpoint of the non-renewable power generation system at various time periods provides and enables a minimization or reduction in an amount of power generation by a non-renewable power generation system since, for example, the setpoint can be set to one that is sufficient but not wasteful to cover the power needs for EV charging during the relevant one or more time intervals in an optimization horizon. In some embodiments, the setpoint may be chosen with the consideration of buffer or safety margin, which may provide some flexibility in a case where the actual power requirement is higher than expected.

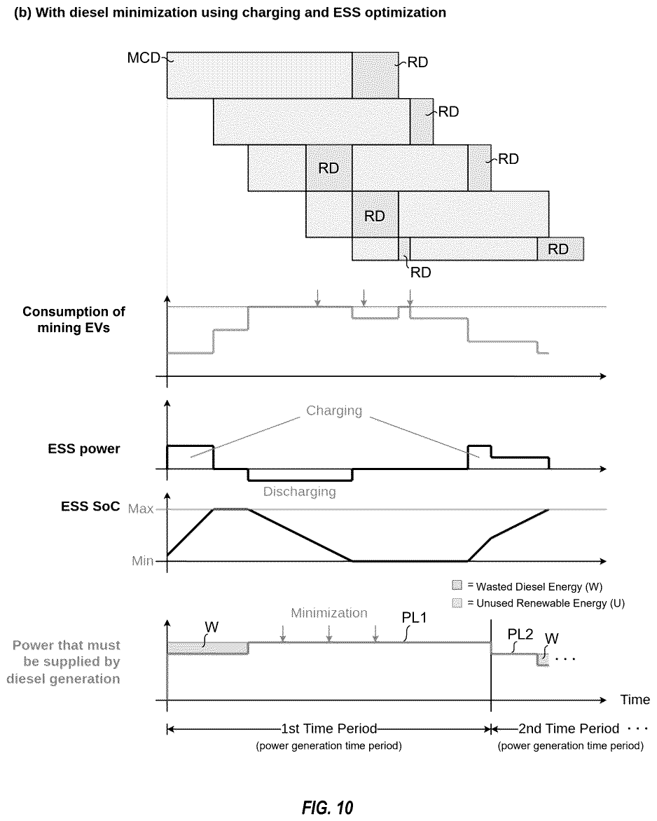

FIG. 10 shows the same EV charging sessions as in FIG. 9. However, the EVs' charging is optimally rearranged to spread out their consumption of power over time as much as possible, subject to the constraints of how long each EV needs to charge for and when it can charge, in order to depart by its target time of departure with its target energy level. As a result, the peak that was present in FIG. 9 due to naively charging most of the EVs simultaneously has been shaved, and the power that would have to be supplied by diesel generation (and wasted at times) has been minimized from 4 units to 3 in the first power generation time period. Note that minimizing the diesel generation, or the optimizer being able to set a lower diesel generation setpoint, does not require that the peak shaving takes into account or knows about the diesel generation; minimizing the diesel generation is a byproduct of the peak shaving on the EVs' power consumption.

FIG. 10 also introduces an ESS being controlled by the optimizer as part of the peak shaving. The peak shaving optimization charges the ESS when there is a valley in the EVs' power generation, and discharges it when there is a peak, such that the combined power consumption of the EVs and ESS is as evenly distributed as possible throughout each of the power generation time periods. The optimizer respects the ESS's minimum and maximum SoC bounds when planning ahead. With its optimal control of the ESS, the optimizer expects the diesel generation to be minimized by an additional 0.5 units. As a result of doing peak shaving with both the EVs and ESS, the power that must be supplied by diesel generation has been minimized from 4 units in FIG. 9 to 2.5 units, allowing a much lower diesel generation setpoint to be used compared to before.

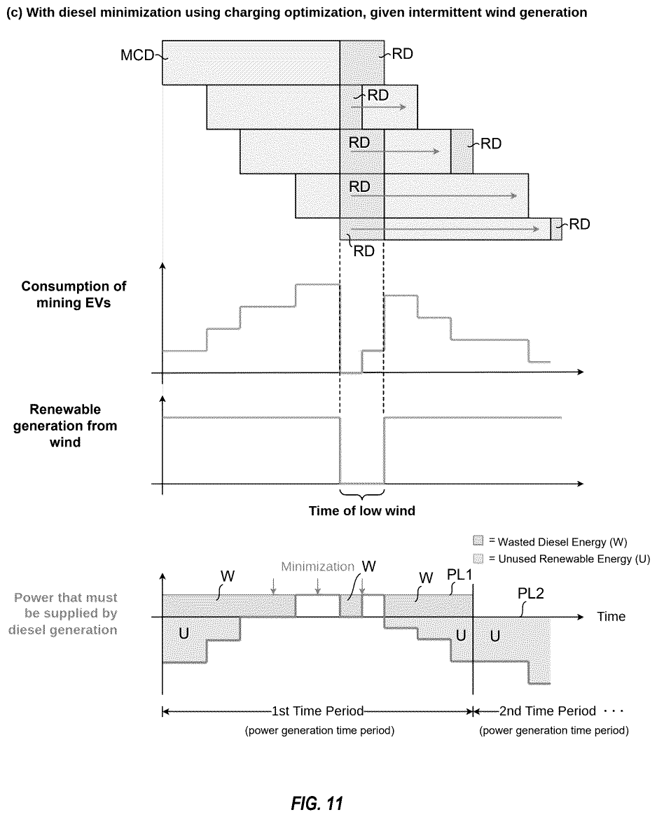

FIG. 11 is an example timing diagram having five mining EVs which arrive for charging in a similar scenario as in FIG. 9 and FIG. 10. However, in this example, the diagram shows an example of an optimized case where the optimizer may do peak shaving for an amount of power that must be supplied by diesel generation and where there is ample on-site renewable generation, for example in the form of wind power. The charging sessions of the five EVs are rearranged to avoid a time of low wind generation, perhaps due to wind momentarily dying down, without needing to prepare by running at a needlessly high setpoint of diesel generation. Instead, the charging power is reduced as much as it can be when the drop in wind generation occurs. Any required charging that remains can be covered with a minimal required setpoint of diesel generation. In this example, the setpoint of power generation for the non-renewable power generation system is set to setpoint PL1 in the first power generation time period, and to setpoint PL2 in the second power generation time period which is shown as zero (where the line is on the x-axis, representing 0) since there is sufficient renewable power generation. Note that although there is some wasted renewable energy, this is better than wasted fuel both from a cost viewpoint and an environmental one. Note that if such intermittency in renewables is frequent, then such a required amount of diesel generation may make installing additional renewable generation useless unless there is an ESS to store it. The optimization done in FIG. 11 is fundamentally similar to that of FIG. 10 and, from an optimization perspective, the wind generation can be thought of as an ESS that only discharges and cannot be controlled, leaving the optimizer to plan around it entirely by rearranging the EVs' charging. If the optimizer were controlling one or more ESSs at the site, then it could combine the optimization done in both figures, charging to absorb a surplus of wind generation and discharging to avoid any diesel whatsoever.

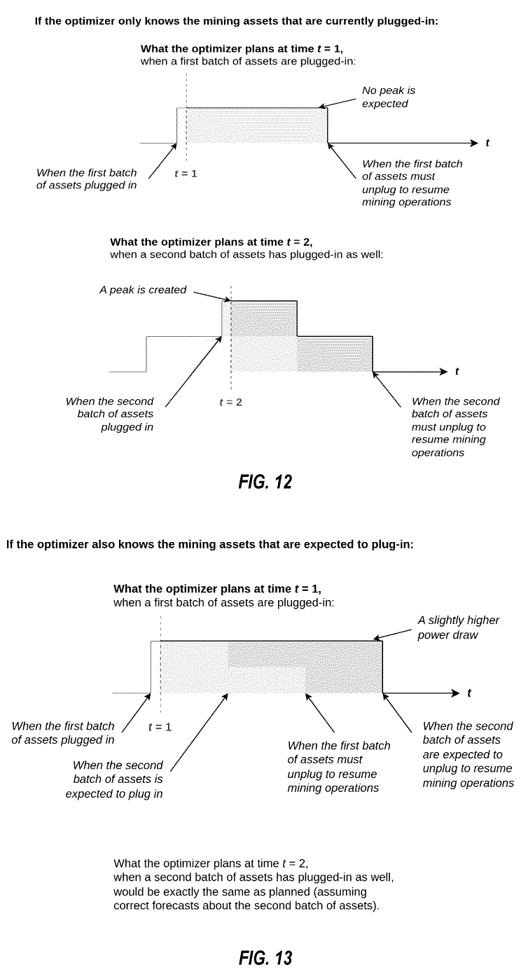

FIG. 12 and FIG. 13 are timing diagrams of examples related to doing peak shifting/shaving in a receding-horizon optimization scheme in which there are a number of mining EVs that are currently plugged-in and possibly expected to depart at some point in the horizon.

FIG. 12 shows an example of when the optimizer is aware of currently plugged-in EVs but has limited or no information about any EVs that may plug-in during the horizon. Here, the optimizer minimizes the highest power that must be supplied by diesel using only this information by distributing the charging of this first batch of mining EVs over time. However, if there are mining EVs that will likely plug-in at later times to which the optimizer had already scheduled charging for the currently plugged-in EVs, these later arriving EVs may create a demand peak for power, resulting in either EVs not being charged sufficiently or requiring more diesel power generation.

FIG. 13 shows an example of when the optimizer is aware of currently plugged-in EVs and also has some information about EVs that may be expected or predicted to plug-in later on in the horizon. Thus, in contrast to the example of FIG. 12, in the present example, if the optimizer has knowledge about mining EVs that are expected to plug-in later in the optimization horizon, the optimizer may be able to plan ahead by spreading out the charging of both the currently plugged-in and future mining EVs, possibly resulting in a higher charging power at first for the currently plugged-in assets relative to the charging power in the example of FIG. 12, but a lower charging power draw when the later EVs plug-in than if these later EVs had not been considered previously.

Furthermore, in at least some embodiments, an optimizer may be configured with one or more objectives, which may be in addition to or alternatively to an objective of minimizing non-renewable fuel usage (e.g. diesel usage) for power generation.

In at least some embodiments, a mine may be connected to a power grid for receiving at least some power to power operations at the mine. A power grid may be any suitable type of grid, including a conventional type of grid for generating and delivering power throughout a region. In such cases, an objective for the optimization, which may be a secondary objective to an objective of minimizing diesel usage, may include peak shaving in relation to power received or taken from the grid connection. Peak shaving may comprise minimizing a highest peak in an optimization horizon that would have to be supplied not from diesel generation but from the power grid. Such peaks may incur demand charges on an electricity bill and/or damage electrical infrastructure. In some embodiments, an optimization objective may include a valley filling objective which may stabilize power taken from the grid by avoiding sudden drops in power draw, such as caused by many mining EVs stopping charging near-simultaneously, and so on. In some embodiments, the optimizer may be configured to use diesel generation to supply the mine to limit an amount of power drawn from the power grid, for example to respect any constraints or other limits of electrical infrastructure which may include the grid connection.

In at least some embodiments, including and perhaps especially if the mine is connected to a power grid, an objective for the optimizer may include TOU energy cost minimization, which may be a secondary objective to an objective of minimizing diesel usage, in which the optimizer may minimize a total TOU energy cost expected in an optimization horizon. TOU energy price over the optimization horizon, current and/or forecasted, may be used as input to the optimizer. The TOU energy price may include carbon tax or carbon credits, particularly if such green initiatives are time-dependent. Assuming that the TOU pricing is associated with power taken from the power grid and there is on-site renewable generation, such an objective may favor the use and ESS-based storage of cheap energy and of on-site renewable generation over taking power from the power grid, which in turn may help reduce GHG emissions, for example any GHG emissions produced in the generation of power supplied by the grid.

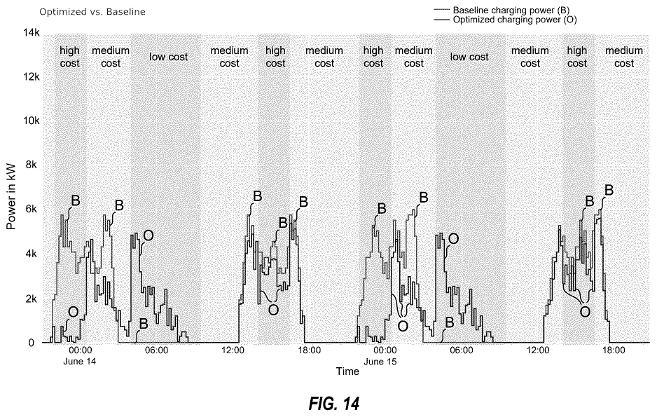

FIG. 14 is a graph showing an example of power used for charging mining EVs, which is similar to the example of FIG. 8 except in the present example TOU cost minimization as the objective is an objective in the optimization. The graph shows non-optimized, or baseline, (red line—B) versus optimized (blue line—O) charging power simulated for two days for a fleet of mining EVs subject to constraints such as when the vehicles are plugged-in and how much energy needs to be delivered. Of particular note for the objective of minimizing TOU electricity costs from the grid, the red-, blue-, and green-shaded time periods represent high-, medium- and low-cost times in which to consume power from the grid, per the TOU pricing scheme. The graph shows that as a result of minimizing the total TOU energy cost, at least some of the charging load is shifted from the high-cost to the medium-cost periods, and from the medium-cost to the low-cost periods, subject to any constraints, thereby doing arbitrage with respect to the energy cost. In another embodiment, the high, medium, and low periods could instead be periods when an energy score is poor, moderate, and good, and where an energy score is an objective of the optimizer.

In at least some embodiments, an objective may relate to maximizing a score such as an energy score, such as previously described. An energy score may be a time series or similar quantity representing a property of available energy, such as how renewable or non-polluting the energy is. An energy score may include or reflect green initiatives such as carbon credits. In some embodiments, an objective may be to maximize a cumulative energy score expected within an optimization horizon. This objective may require a forecasted energy score over the optimization horizon, and possibly a current energy score, as an additional input to the optimizer. Such an objective may help reduce GHG emissions. A simple example implementation of this may include charging mining EVs and/or any ESS less when the energy score is low, potentially charging the mining EVs using the ESS, and charging the mining EVs and/or ESS more when the energy score is high, thereby doing arbitrage with respect to the energy score.

In at least some embodiments, an objective may relate to having a predetermined number of mining EVs operating at specific times. For example, a mine operator may desire that a minimum number of mining EVs are operating at any given time, or at specific times, and/or there may be a maximum throughput of some processing of mined materials. As such, it may be desirable to optimize operating schedules of mining EVs as opposed to, or in addition to, optimizing charging schedules of E Vs, to potentially spread out over time the operation of the EVs or to ensure that a number of EVs operating at any given time or at specific times is within certain ranges, which may be represented by an optimization objective or constraints, respectively. Such objectives may support or relate to any peak shifting/shaving objectives or the constraints/limits of the electrical infrastructure of the mine.

In at least some embodiments, an objective may relate to maintaining relatively smooth power flows over time. For example, it may be desirable to have smooth power flows over time, as opposed to having many or large fluctuations, for the sake of stability, performance, and so on. Since on-site non-renewable power generation may take time to start up or to stop, for example time needed to spin up a diesel generator, an optimizer may be configured to favor discharging ESS(s) to counteract peaks and charging ESS(s) to counteract drops. Furthermore, if starting or stopping diesel generation completely would cause an instability or interruption or cause some other undesired effect, rather than the optimizer shutting off some or all diesel generators for a given time period, the optimizer may instead run some or all of the generators at a low setpoint such as a lowest setpoint that a generator will allow. Thus, in such cases, diesel generators would not need to be stopped completely.

Up to this point, some uses of optimizations and predictors and have been described, including in a context operations at a mine, which may be subject to the pre-existing assets of the mine, for example mining EVs and other assets, diesel or other non-renewable generators, any renewable generation sources, and any ESSs. However, during a process of introducing mining EVs, renewable power generation, and/or ESSs at an existing or new mine, many decisions would be expected to have to be made such as how many and what specification of these EVs or other electric assets to purchase.

Such decisions typically come with high costs but may have important long-term cost reduction implications since they may affect how much and what kind of optimization may be performed once a mine is established with the new EVs. Such decisions are often interrelated because, for example, the decision of which mining EV to purchase may affect how much electrical energy the mine needs to provide. In the case of a mixed fleet, meaning a fleet having both non-electric and electric vehicles or other assets, a decision of which mining assets to electrify and which to keep as non-electric, for example diesel or gas powered, may affect when energy is needed to recharge the EVs. In addition, how much energy is required and when it is needed may affect how much power generation to install and the types of generation, for example diesel versus renewables. Furthermore, such factors may be push-pull factors. For example, while the types of EVs affect the amount of energy needed, the amount of energy that can actually be provided may affect how various vehicles can be replaced with EVs. In addition, decisions may also be limited by, for example, the amounts of types of renewable energy that are available at the mine.

Furthermore, in another aspect, the present disclosure relates to generating and running simulations relating to operations at a mine to enhance or improve decisions such as those noted above. Many such decisions tend to be informed by simple calculations, which are often easier but rely on making assumptions and approximations. A mine, and the way some operations of the mine are optimized, are best modeled by a simulation because they represent a system that is time-variant, for example due to changing mining activities, fluctuating renewables, etc. In addition, such a system is also often a causal system, wherein past optimizations have lasting effects. Decisions can be informed by running simulations of a mine and its optimization over time and comparing the simulation results, rather than, for example, trying to use simple calculations. This may allow planners to assess one or more of whether a given set of assets for a mine will feasibly work together over time or whether, for example, the electric mining assets will not always be charged on-time or an ESS will be depleted; if a given set of EVs will feasibly work together, for example whether they result in a lower long-term cost (for example considering both up-front and operating costs of the assets) or lower diesel wastage or GHG emissions.

These approaches of using simulations for making decisions may include the same or similar kind of optimizations that may be performed in a real-world implementation, and may make it easier to optimally electrify and minimize diesel wastage at a mine.

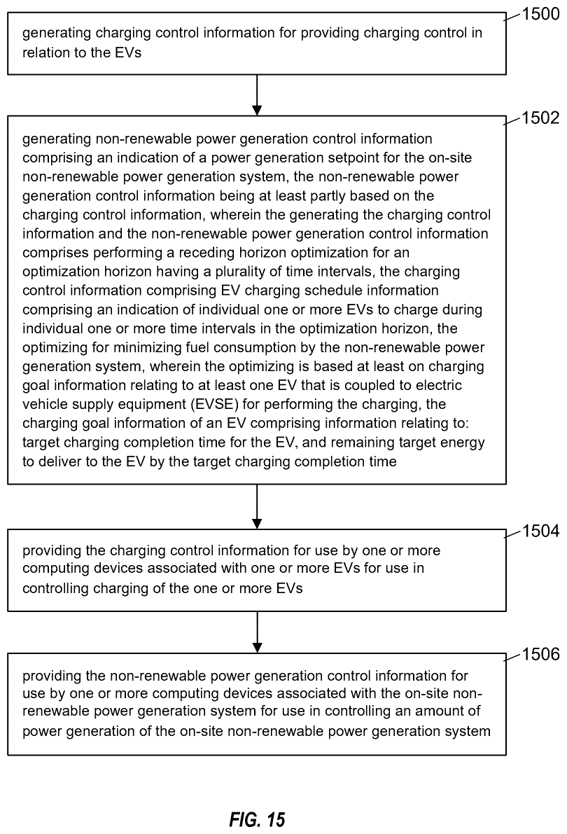

FIG. 15 is a process flow diagram of an example method. The example method may be performed at or by one or more electronic devices each having one or more computer processors and computer-readable memory. The method may provide control in relation to operations of EVs and/or other assets, for example at a mine, or at any other site(s) or location(s). In particular, the method may relate to providing control in relation to charging of mining EVs or other assets and/or generation of power using a non-renewable power generation system. The charging may be performed using power received at least in part from a non-renewable power generation system that may be separate from a power grid. The non-renewable power generation system may be on-site.

At block 1500, the method may comprise generating charging control information for providing charging control in relation to the EVs.

At block 1502, the method may comprise generating non-renewable power generation control information comprising an indication of a power generation setpoint for the on-site non-renewable power generation system, the non-renewable power generation control information being at least partly based on the charging control information. The generating the charging control information and the non-renewable power generation control information may comprise or be based on performing a receding horizon optimization for an optimization horizon having a plurality of time intervals, the charging control information comprising EV charging schedule information comprising an indication of individual one or more EVs to charge during individual one or more time intervals in the optimization horizon. The optimizing may be for minimizing fuel consumption by the non-renewable power generation system, wherein the optimizing is based at least on charging goal information relating to at least one EV that is coupled to electric vehicle supply equipment (EVSE) for performing the charging. The charging goal information of an EV comprising information may relate to target charging completion time for the EV, and remaining target energy to deliver to the EV by the target charging completion time.

At block 1504, the method may comprise providing the charging control information for use by one or more computing devices associated with one or more EVs for use in controlling charging of the one or more EVs.

At block 1506, the method may comprise providing the non-renewable power generation control information for use by one or more computing devices associated with the on-site non-renewable power generation system for use in controlling an amount of power generation of the on-site non-renewable power generation system.

The teachings according to the present disclosure may be used with a mixed fleet of assets, meaning a group comprising EVs or other electric assets and non-electric vehicles or assets. The term “fleet” is used generally herein. It may refer to a group of vehicles of an organization, such as a mining company or entity. However, the term also includes one or more vehicles that are associated with one another in some way, and not necessarily all associated with one organization.

The terms “prediction” and “predictor” are generally used herein for simplicity to include forecasts and forecasters, and estimates and estimators. Although, in some instances, the terms forecast and forecaster may be used, for example “weather forecast” and so on. In addition, the terms “status” and “state” are generally used interchangeably.

In addition, the terms “power” and “energy” are often used interchangeably, for example that an ESS stores power or energy.

In some embodiments, algorithms, techniques, and/or approaches according to the present disclosure may be performed or based on artificial intelligence (Al) algorithms, techniques, and/or approaches. This includes but is not limited to systems, controllers, optimizers and/or predictors according to the present disclosure, as well as controlling of EVs or other controllable assets, for example EVs, power generation systems, ESSs, EV chargers or other EV charging architecture, and so on.

In some embodiments, the Al algorithms and techniques may include machine learning techniques.

Machine Learning (ML) may be used in one or more aspects of a power control system according to the present disclosure. Machine learning models may be used to generate control information for providing control in relation to assets in a system, for instance using one or more optimizations. Machine learning systems or models may be used to implement predictors to predict information as described herein. Machine learning models may be generated and used to optimize or otherwise calculate in relation to one or more objectives according to the present disclosure, for example minimizing the use of fuel by a non-renewable power generation system.

A machine learning algorithm or system may receive data, for example historical data, streaming controllable asset data, environmental data, and/or third party data, and, using one or more suitable machine learning algorithms, may generate one or more datasets. Example types of machine learning algorithms include but are not limited to supervised learning algorithms, unsupervised learning algorithms, reinforcement learning algorithms, semi-supervised learning algorithms (for example where both labeled and unlabeled data is used), regression algorithms (for example logistic regression, linear regression, and so forth), regularization algorithms (for example least-angle regression, ridge regression, and so forth), artificial neural network algorithms, instance based algorithms (for example locally weighted learning, learning vector quantization, and so forth), Bayesian algorithms, decision tree algorithms, clustering algorithms, and so forth. Further, other machine learning algorithms may be used additionally or alternatively. In some embodiments, a machine learning algorithm or system may analyze data to identify patterns and/or sequences of activity, and so forth, to generate one or more datasets.

A power control system may comprise one or more control policies. The control policies of the system may be based on trained machine learning based systems. In this sense, a control policy may be part of a controller or control agent. A control agent observes its environment, which may be referred to as a control environment, and takes action based on its observations, or percepts, of the control environment. The taking of action is referred to as controlling the system, which may include providing control in relation to assets in or associated with the system. Depending on the state of the environment, taking action may involve taking no action at all with respect to the system outputs, for example if there has been little or no change in the state since the last time the agent took action. Thus, doing nothing (not updating any setpoints, etc.) is a valid action in a set of actions in the action space of the controller. In at least some embodiments, the present systems and methods may exploit the flexibility of controllable assets in the system to achieve improved performance of the system. For example, the flexibility of controllable assets may be exploited in response to changes in the control environment.

In at least some embodiments, online machine learning may be employed. Online machine learning is a technique of machine learning where data becomes available sequentially over time. The data is utilized to update a predictor for future data at each step in time (for example time slot). This approach of online machine learning may be contrasted to approaches that use batch learning wherein learning performed on an entire or subset of training data set. Online machine learning is sometimes useful where the data varies significantly over time, such as in power or energy pricing, commodity pricing, and stock markets. Further, online machine learning may be helpful when it is not practical or possible to train the agent over the entirety or a subset of a data set.

In at least some embodiments according to the present disclosure, training of a machine learning system, such as controller, optimizer, and/or predictor, may be based on offline learning and/or online learning where streaming real-time data may be combined with at least some data, for example from a database to train the machine learning system in real-time or near real-time. Over time, a machine learning system may be retrained, for example with newer or different training data.

The concept of explainable Al is gaining increasing popularity in Al software systems, such as those using ML or RL techniques, and particularly where the Al model is a “black box” such as whose inner workings are difficult to understand or explain, especially to a layperson. This may apply to at least some of the methods and systems according to the present disclosure that employ AI techniques such as ML, for example as an ML- or RL-based optimizer. That being said, the concept of explainable Al may be generalized to being able to explain software systems' actions to those affected by them (for example, users of the system), whether the action is based on Al or not. For example, if the system is being used for multi-objective optimization wherein different, conflicting sub-objectives culminate into one, overall objective to which the optimization is applied, then the numerical weightings with which the sub-objectives may be combined can help explain the optimizer's action according to those weightings. This may notably include soft constraints which are factored into the overall objective as sub-objectives. For example, if a fleet operator assigned a high weighting to minimizing usage or wastage of fuel by a non-renewable power generation system and a low weighting to minimizing GHG emissions (thereby prioritizing the former objective over the latter), then operators and other system users being made readily aware of such facts would aid in the overall understanding, trust, and adoption of such systems.

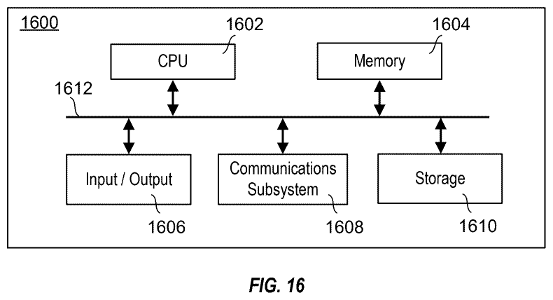

FIG. 16 is a block diagram of an example computerized device or system 1600 that may be used in implementing one or more aspects or components of an embodiment according to the present disclosure. For example, system 1600 may be used to implement a computing device or system, such as a power control system, an optimizer, a predictor, a controller, and so on, to be used with a device, system or method according to the present disclosure. Thus, one or more systems 1600 may be configured to implement one or more portions of the systems or apparatuses or methods according to the present disclosure.

Computerized system 1600 may comprise one or more of classic, analog, electronic, digital, and quantum computing technologies. Computerized system 1600 may include one or more of a computer processor device 1602, memory 1604, a mass storage device 1610, an input/output (I/O) interface 1606, and a communications subsystem 1608. A computer processor device may be any suitable device(s), and encompasses various devices, systems, and apparatus for processing data and instructions. These include, as examples only, one or more of a hardware processor, a digital processor, an electronic processor, a quantum processor, a programmable processor, a computer, a system on a chip, and special purpose logic circuitry such as an ASIC (application-specific integrated circuit) and/or FPGA (field programmable gate array). In addition, system 1600 may include hardware dedicated to one or more specific purposes, such as a graphics processing unit (GPU), or a tensor processing unit (TPU) or other artificial intelligence accelerator ASIC, for example for ML.

Memory 1604 may be configured to store computer readable instructions, that when executed by processor 1602, cause the performance of operations, including operations in accordance with the present disclosure.

One or more of the components or subsystems of computerized system 1600 may be interconnected by way of one or more buses 1612 or in any other suitable manner.

The bus 1612 may be one or more of any type of several bus architectures including a memory bus, storage bus, memory controller bus, peripheral bus, or the like. The processor 1602 may comprise any type of electronic data processor. The memory 1604 may comprise any type of system memory such as dynamic random access memory (DRAM), static random access memory (SRAM), synchronous DRAM (SDRAM), read-only memory (ROM), a combination thereof, or the like. In an embodiment, the memory may include ROM for use at boot-up, and DRAM for program and data storage for use while executing programs.

The mass storage device 1610 may comprise any type of storage device configured to store data, programs, and other information and to make the data, programs, and other information accessible via the bus 1612. The storage device may be adapted to store one or more databases and/or data repositories, each of which is generally an organized collection of data or other information stored and accessed electronically via a computer. The term database or repository may thus refer to a storage device comprising a database. The mass storage device 1610 may comprise one or more of a solid state drive, hard disk drive, a magnetic disk drive, an optical disk drive, or the like. In some embodiments, data, programs, or other information may be stored remotely, for example in the cloud. Computerized system 1600 may send or receive information to the remote storage in any suitable way, including via communications subsystem 1608 over a network or other data communication medium.

The I/O interface 1606 may provide interfaces for enabling wired and/or wireless communications between computerized system 1600 and one or more other devices or systems, such as a power control system according to the present disclosure. Furthermore, additional or fewer interfaces may be utilized. For example, one or more serial interfaces such as Universal Serial Bus (USB) (not shown) may be provided. Further, system 1600 may comprise or be communicatively connectable to a display device, and/or speaker device, a microphone device, an input device such as a keyboard, button, pointer, mouse, touch screen display, microphone, camera, scanner, or any other type of input device.

Computerized system 1600 may be used to configure, operate, control, monitor, sense, and/or adjust devices, systems, and/or methods according to the present disclosure.

A communications subsystem 1608 may be provided for one or both of transmitting and receiving signals over any form or medium of digital data communication, including a communication network. Examples of communication networks include a local area network (LAN), a wide area network (WAN), telecommunications network, cellular network, an inter-network such as the Internet, and peer-to-peer networks such as ad hoc peer-to-peer networks. Communications subsystem 1608 may include any component or collection of components for enabling communications over one or more wired and wireless interfaces. These interfaces may include but are not limited to USB, Ethernet (for example IEEE 802.3), high-definition multimedia interface (HDMI), Firewire™ (for example IEEE 1374), Thunderbolt™, WiFi™ (for example IEEE 802.11), WiMAX (for example IEEE 802.16), Bluetooth™, or Near-field communications (NFC), as well as General Packet Radio Service (GPRS), Universal Mobile Telecommunications System (UMTS), Long-Term Evolution (LTE), LTE-A, 5G NR (New Radio), satellite communication protocols, and dedicated short range communication (DSRC). Communication subsystem 1608 may include one or more ports or other components (not shown) for one or more wired connections. Additionally or alternatively, communication subsystem 1608 may include one or more transmitters, receivers, and/or antenna elements (none of which are shown). Further, system 1600 may comprise clients and servers.

Computerized system 1600 of FIG. 16 is merely an example and is not meant to be limiting. Various embodiments may utilize some or all of the components shown or described. Some embodiments may use other components not shown or described but known to persons skilled in the art.

Logical operations of the various embodiments according to the present disclosure may be implemented as (i) a sequence of computer implemented steps, procedures, or operations running on a programmable circuit in a computer, (ii) a sequence of computer implemented operations, procedures, or steps running on a specific-use programmable circuit; and/or (iii) interconnected machine modules or program engines within the programmable circuits. The computerized device or system 1600 of FIG. 16 may practice all or part of the recited methods or operations, may be a part of systems according to the present disclosure, and/or may operate according to instructions in computer-readable storage media. Such logical operations may be implemented as modules configured to control a computer processor, such as processor 1602, to perform particular functions according to the programming of the module. In other words, a computer processor, such as processor 1602, may execute the instructions, steps, or operations according to the present disclosure, including of the one or more of the blocks or modules. For example, one or more of the modules or blocks in the figures, for example in FIG. 4 or 5 may be configured to control processor 1602. For example, the modules or blocks in FIG. 4 or 5 may include but are not limited to, for example, power control system 402, 502 an optimizer(s), predictors, and so on. At least some of these blocks or modules may be stored on storage device 1610 and loaded into memory 1604 at runtime or may be stored in other computer-readable memory locations.

The concepts of real-time and near real-time may be defined as providing a response or output within a pre-determined time interval, usually a relatively short time. A time interval for real-time is generally shorter than an interval for near real-time. Mere non-limiting examples of predetermined time intervals may include the following as well as values below, between, and/or above these figures: 10 s, 60 s, 5 min, 10 min, 20 min, 30 min, 60 min, 2 hr, 4 hr, 6 hr, 8 hr, 10 hr, 12 hr, 1 day.

The term module used herein may refer to a software module, a hardware module, or a module comprising both software and hardware. Generally, software includes computer executable instructions, and possibly also data, and hardware refers to physical computer hardware.

The term ‘data’ generally refers to raw or unorganized facts whereas ‘information’ generally refers to processed or organized data. However, the terms are generally used synonymously herein unless indicated otherwise.

Embodiments, components, subsystems, and operations according to the present disclosure may be implemented in digital electronic circuitry, and/or in computer software, firmware, and/or hardware, including structures according to this disclosure and their structural equivalents. Embodiments and operations according to the present disclosure may be implemented as one or more computer programs, for example one or more modules of computer program instructions, stored on or in computer storage media for execution by, or to control the operation of, one or more computer processing devices such as a processor. Operations according to the present disclosure may be implemented as operations performed by one or more processing devices on data stored on one or more computer-readable storage devices or media, and/or received from other sources.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not necessarily provided as to whether the embodiments described herein are implemented as a computer software, computer hardware, electronic hardware, or a combination thereof.

In at least some embodiments, one or more aspects or components may be implemented by one or more special-purpose computing devices. The special-purpose computing devices may be any suitable type of computing device, including desktop computers, portable computers, handheld computing devices, networking devices, or any other computing device that comprises hardwired and/or program logic to implement operations and features according to the present disclosure.

Embodiments of the disclosure may be represented as a computer program product stored in a machine-readable medium (also referred to as a computer-readable medium, a processor-readable medium, or a computer usable medium having a computer-readable program code embodied therein). The machine-readable medium may be any suitable tangible, non-transitory medium, including magnetic, optical, or electrical storage medium including a diskette, compact disk read only memory (CD-ROM), memory device (volatile or non-volatile), or similar storage mechanism. The machine-readable medium may contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations may also be stored on the machine-readable medium. The instructions stored on the machine-readable medium may be executed by a processor or other suitable processing device, and may interface with circuitry to perform the described tasks.

The structure, features, accessories, and/or alternatives of embodiments described and/or shown herein, including one or more aspects thereof, are intended to apply generally to all of the teachings of the present disclosure, including to all of the embodiments described and illustrated herein, insofar as they are compatible. Thus, the present disclosure includes embodiments having any combination or permutation of features of embodiments or aspects herein described.

In addition, the steps and the ordering of the steps of methods and data flows described and/or illustrated herein are not meant to be limiting. Methods and data flows comprising different steps, different number of steps, and/or different ordering of steps are also contemplated. Furthermore, although some steps are shown as being performed consecutively or concurrently, in other embodiments these steps may be performed concurrently or consecutively, respectively.

For simplicity and clarity of illustration, reference numerals may have been repeated among the figures to indicate corresponding or analogous elements. Numerous details have been set forth to provide an understanding of the embodiments described herein. The embodiments may be practiced without these details. In other instances, well-known methods, procedures, and components have not been described in detail to avoid obscuring the embodiments described.

The embodiments according to the present disclosure are intended to be examples only. Alterations, modifications and variations may be effected to the particular embodiments by those of skill in the art without departing from the scope, which is defined solely by the claims appended hereto.

Terms such as “comprising”, “comprises”, “including,” “includes,” “having,” “has,” “with,” and variants thereof as used herein generally mean includes but not necessarily limited to. The terms “a” or “an” are generally used to mean one or more than one. Furthermore, the term “or” is used in a non-exclusive manner, meaning that “A or B” includes “A but not B,” “B but not A,” and “both A and B” unless otherwise indicated. In addition, the terms “first,” “second,” and “third,” and so on, are used only as labels for descriptive purposes, and are not intended to impose numerical requirements or any specific ordering on their objects.

1. A system, comprising:
a computer-readable storage medium having executable instructions; and
one or more computer processors configured to execute the instructions to provide control in relation to charging of a plurality of electric vehicles (EVs), wherein the charging is performed using power received at least in part from an on-site non-renewable power generation system that is separate from a power grid, the instructions to:
generate charging control information for providing charging control in relation to the EVs;
generate non-renewable power generation control information comprising an indication of a power generation setpoint for the on-site non-renewable power generation system, the non-renewable power generation control information being at least partly based on the charging control information,
wherein the generating the charging control information and the non-renewable power generation control information comprises performing a receding horizon optimization for an optimization horizon having a plurality of time intervals, the charging control information comprising EV charging schedule information comprising an indication of individual one or more EVs to charge during individual one or more time intervals in the optimization horizon, the optimizing for minimizing fuel consumption by the non-renewable power generation system, wherein the optimizing is based at least on charging goal information relating to at least one EV that is coupled to electric vehicle supply equipment (EVSE) for performing the charging, the charging goal information of an EV comprising information relating to:
target charging completion time for the EV; and
remaining target energy to deliver to the EV by the target charging completion time;
provide the charging control information for use by one or more computing devices associated with one or more EVs for use in controlling charging of the one or more EVs; and
provide the non-renewable power generation control information for use by one or more computing devices associated with the on-site non-renewable power generation system for use in controlling an amount of power generation of the on-site non-renewable power generation system.

2. The system according to claim 1, wherein the non-renewable power generation control information is for a first power generation time period, the instructions further to, for a second power generation time period subsequent to the first power generation time period, generate an indication of a new power generation setpoint for the second power generation time period based on generated charging control information for one or more time intervals during the second power generation time period, the new power generation setpoint differing from the power generation setpoint for the first power generation time period.

3. The system according to claim 1,
wherein the on-site non-renewable power generation system comprises a plurality of non-renewable power generators, and
wherein the indication of a power generation setpoint for the on-site non-renewable power generation system comprises indications of a power generation setpoint for each of at least two of the plurality of non-renewable power generators.

4. The system according to claim 3, wherein the indications of a power generation setpoint for each of at least two of the plurality of non-renewable power generators comprises an indication to at least one of: start up at least one of the non-renewable power generators, turn off at least one of the non-renewable power generators, and operate at least one of the non-renewable power generators at a minimum operating power level instead of turning off the non-renewable power generator.

5. The system according to claim 1, wherein the optimizing comprises performing peak shaving to reduce an overall amount of energy required for charging during a peak shaving time period, the peak shaving comprising generating EV charging schedule information with at least some shifted charging of individual one or more EVs during individual one or more time intervals in the optimization horizon.

6. The system according to claim 1, wherein the optimization is further based on prediction information relating to predicted on-site renewable power generation during the optimization horizon, wherein at least some of the on-site renewable power is available for EV charging, and wherein the power generation setpoint for the on-site non-renewable power generation system is based on the predicted on-site renewable power generation.

7. The system according to claim 1, wherein the optimization is further based on prediction information relating to predicted energy available for charging stored in an energy storage system (ESS) during the optimization horizon, and wherein the power generation setpoint for the on-site non-renewable power generation system is based on the predicted energy stored in the ESS.

8. The system according to claim 1, wherein the optimizing is further based on prediction information relating to EVs predicted to become available for charging during the optimization horizon, the prediction information comprising:
predicted time an EV becomes available for charging;
predicted target charging completion time for the EV;
predicted target energy to deliver to the EV by the target charging completion time.

9. The system according to claim 1, instructions further to:
control the charging of the one or more EVs based on the charging control information by controlling the operation of EVSE and/or one or more EVs to charge the individual EVs; and
control the amount of power generation of the on-site non-renewable power generation system based on the non-renewable power generation control information by setting a power generation setpoint of the on-site non-renewable power generation system.

10. A method comprising:
at one or more electronic devices each having one or more processors and computer-readable memory, to provide control in relation to charging of a plurality of electric vehicles (EVs), wherein the charging is performed using power received at least in part from an on-site non-renewable power generation system that is separate from a power grid:
generating charging control information for providing charging control in relation to the EVs;
generating non-renewable power generation control information comprising an indication of a power generation setpoint for the on-site non-renewable power generation system, the non-renewable power generation control information being at least partly based on the charging control information,
wherein the generating the charging control information and the non-renewable power generation control information comprises performing a receding horizon optimization for an optimization horizon having a plurality of time intervals, the charging control information comprising EV charging schedule information comprising an indication of individual one or more EVs to charge during individual one or more time intervals in the optimization horizon, the optimizing for minimizing fuel consumption by the non-renewable power generation system, wherein the optimizing is based at least on charging goal information relating to at least one EV that is coupled to electric vehicle supply equipment (EVSE) for performing the charging, the charging goal information of an EV comprising information relating to:
target charging completion time for the EV; and
remaining target energy to deliver to the EV by the target charging completion time;
providing the charging control information for use by one or more computing devices associated with one or more EVs for use in controlling charging of the one or more EVs; and
providing the non-renewable power generation control information for use by one or more computing devices associated with the on-site non-renewable power generation system for use in controlling an amount of power generation of the on-site non-renewable power generation system.

11. The method according to claim 10, wherein the non-renewable power generation control information is for a first power generation time period, the method further comprising, for a second power generation time period subsequent to the first power generation time period, generating an indication of a new power generation setpoint for the second power generation time period based on generated charging control information for one or more time intervals during the second power generation time period, the new power generation setpoint differing from the power generation setpoint for the first power generation time period.

12. The method according to claim 10,
wherein the on-site non-renewable power generation system comprises a plurality of non-renewable power generators, and
wherein the indication of a power generation setpoint for the on-site non-renewable power generation system comprises indications of a power generation setpoint for each of at least two of the plurality of non-renewable power generators.

13. The method according to claim 12, wherein the indications of a power generation setpoint for each of at least two of the plurality of non-renewable power generators comprises an indication to at least one of: start up at least one of the non-renewable power generators, turn off at least one of the non-renewable power generators, and operate at least one of the non-renewable power generators at a minimum operating power level instead of turning off the non-renewable power generator.

14. The method according to claim 10, wherein the optimizing comprises performing peak shaving to reduce an overall amount of energy required for charging during a peak shaving time period, the peak shaving comprising generating EV charging schedule information with at least some shifted charging of individual one or more EVs during individual one or more time intervals in the optimization horizon.

15. The method according to claim 10, wherein the optimization is further based on prediction information relating to predicted on-site renewable power generation during the optimization horizon, wherein at least some of the on-site renewable power is available for EV charging, and wherein the power generation setpoint for the on-site non-renewable power generation system is based on the predicted on-site renewable power generation.

16. The method according to claim 10, wherein the optimization is further based on prediction information relating to predicted energy available for charging stored in an energy storage system (ESS) during the optimization horizon, and wherein the power generation setpoint for the on-site non-renewable power generation system is based on the predicted energy stored in the ESS.

17. The method according to claim 10, wherein the optimizing is further based on prediction information relating to EVs predicted to become available for charging during the optimization horizon, the prediction information comprising:
predicted time an EV becomes available for charging;
predicted target charging completion time for the EV;
predicted target energy to deliver to the EV by the target charging completion time.

18. The method according to claim 10, further comprising:
controlling the charging of the one or more EVs based on the charging control information by controlling the operation of EVSE and/or one or more EVs to charge the individual EVs; and
controlling the amount of power generation of the on-site non-renewable power generation system based on the non-renewable power generation control information by setting a power generation setpoint of the on-site non-renewable power generation system.

19. A non-transitory computer-readable medium having computer-readable instructions stored thereon, the computer-readable instructions executable by at least one processor to cause the performance of operations relating to providing control in relation to charging of a plurality of electric vehicles (EVs), wherein the charging is performed using power received at least in part from an on-site non-renewable power generation system that is separate from a power grid, the operations comprising:
generating charging control information for providing charging control in relation to the EVs;
generating non-renewable power generation control information comprising an indication of a power generation setpoint for the on-site non-renewable power generation system, the non-renewable power generation control information being at least partly based on the charging control information,
wherein the generating the charging control information and the non-renewable power generation control information comprises performing a receding horizon optimization for an optimization horizon having a plurality of time intervals, the charging control information comprising EV charging schedule information comprising an indication of individual one or more EVs to charge during individual one or more time intervals in the optimization horizon, the optimizing for minimizing fuel consumption by the non-renewable power generation system, wherein the optimizing is based at least on charging goal information relating to at least one EV that is coupled to electric vehicle supply equipment (EVSE) for performing the charging, the charging goal information of an EV comprising information relating to:
target charging completion time for the EV; and
remaining target energy to deliver to the EV by the target charging completion time;
providing the charging control information for use by one or more computing devices associated with one or more EVs for use in controlling charging of the one or more EVs; and
providing the non-renewable power generation control information for use by one or more computing devices associated with the on-site non-renewable power generation system for use in controlling an amount of power generation of the on-site non-renewable power generation system.

20. The non-transitory computer-readable medium according to claim 19, wherein the non-renewable power generation control information is for a first power generation time period, the method further comprising, for a second power generation time period subsequent to the first power generation time period, generating an indication of a new power generation setpoint for the second power generation time period based on generated charging control information for one or more time intervals during the second power generation time period, the new power generation setpoint differing from the power generation setpoint for the first power generation time period.
